(19) United States
(12) Patent Application Publication
(10) Pub. No.: US 2025/0199429 A1
(43) Pub. Date: Jun. 19, 2025

(54) TONER

(71) Applicant: CANON KABUSHIKI KAISHA, Tokyo (JP)

(72) Inventors: KENTARO YAMAWAKI, Shizuoka (JP); YUKI MASUDA, Shizuoka (JP); SHUHEI IWASAKI, Kanagawa (JP); KENJI AOKI, Shizuoka (JP)

(21) Appl. No.: 18/970,453

(22) Filed: Dec. 5, 2024

(30) Foreign Application Priority Data
Dec. 13, 2023 (JP) 2023-210508

(51) Int. Cl. G03G 9/093

(52) U.S. Cl. CPC G03G 9/09364; G03G 9/09321; G03G 9/09328

(57) ABSTRACT

A toner including a toner particle, wherein the toner particle includes a core containing a binder resin, and a shell covering the core, the binder resin includes a crystalline vinyl resin (A), the crystalline vinyl resin (A) containing at least 5.0% by mass of a monomer unit (a) having at least two of alkyl group having 16 to 30 carbon atoms, the shell is an amorphous resin, and the SP value of the amorphous resin and the SP value of the crystalline vinyl resin (A) satisfy specific relationship.

### BACKGROUND OF THE INVENTION

### Field of the Invention

The present disclosure relates to a toner for use in electrophotography and electrostatic recording.

### Description of the Related Art

A method for visualizing image information using a toner, such as electrophotography, is presently used in various fields, and there is a demand for improved performance, i.e., higher image quality as well as energy saving. In the electrophotography method, an electrostatic latent image is first formed on an electrophotographic photosensitive member (image carrier) through charging and exposure steps. Next, the electrostatic latent image is developed with a developer containing a toner, and a visualized image (fixed image) is obtained through a transfer step and a fixing step.

Among these steps, the fixing step requires a relatively large amount of energy, and the development of a system and materials that make it possible to achieve both energy saving and high image quality is an important technological problem to be addressed. As an approach from the material standpoint, a technique using a crystalline resin as the binder resin of the toner is being considered. Crystalline resins have excellent heat-resistant storage stability because the molecular chains are regularly arranged and hence the resins hardly soften at temperatures lower than the melting point. Meanwhile, when the melting point is exceeded, the crystals melt suddenly, which is accompanied by a rapid drop in viscosity. For this reason, crystalline resins having excellent sharp melt property attract attention as materials that exhibit low-temperature fixability.

Main-chain crystalline resins, which are represented by crystalline polyesters and in which the main chain crystallizes, and side-chain crystalline resins, which are represented by long-chain alkyl acrylate polymers and in which the side chains crystallize, are known as crystalline resins. Among them, side-chain crystalline resins are known to exhibit excellent low-temperature fixability because the degree of crystallinity thereof is easy to increase, and such resins have been widely studied. Side-chain crystalline resins can be exemplified by crystalline vinyl resins. Crystalline vinyl resins have long-chain alkyl groups as side chains, and the long-chain alkyl groups in the side chains are oriented to each other and hence exhibit crystallinity.

Japanese Patent Application Publication No. 2020-173414 discloses a toner using a crystalline vinyl resin obtained by copolymerization of a polymerizable monomer having a long-chain alkyl group and an amorphous polymerizable monomer having a different SP value.

Crystalline vinyl resins exhibit excellent performance in terms of low-temperature fixability and heat-resistant storage stability, but have a problem with charging performance due to a low charge retention property thereof. Japanese Patent Application Publication No. 2019-219647 discloses a technique that solves the problem of charging performance by forming a shell with a uniform and high coverage ratio by using an amorphous resin.

### SUMMARY OF THE INVENTION

The technique of Japanese Patent Application Publication No. 2019-219647 excels in improving the charging performance, which is a problem with crystalline vinyl resins. Meanwhile, it has been found that when a product is transported by sea in a condition where temperature and humidity are not controlled, such as in a dry container on a cargo ship, excellent charging performance may not be exhibited after transportation. Cargo ships are exposed to environments with large temperature and humidity differences between day and night depending on the region the cargo ships pass through, the weather, and the loading position. For example, on routes that pass directly under the equator, the ships are exposed to an environment where a cycle, in which the temperature is around 20° C. at night and rises to around 60° C. during the day, is repeated every day. With the recent progress of global warming, it is expected that the environments to which the ships are exposed will become even harsher in the future.

As described above, although charging performance has been improved using the conventional techniques, it has been found that excellent charging performance may not be achieved when the toner is transported by sea in conditions where temperature and humidity are not controlled.

The present disclosure is directed to a toner that contains a crystalline vinyl resin, which has excellent low-temperature fixability and heat-resistant storage stability, and that is less likely to exhibit changes in charging performance even in an environment where significant changes in temperature and humidity occur.

According to at least one aspect of the present disclosure, there is provided a toner comprising a toner particle, wherein
the toner particle comprises
   a core comprising a binder resin, and
   a shell covering the core,
the binder resin comprises a crystalline vinyl resin (A),
the crystalline vinyl resin (A) comprises at least 5.0% by mass of a monomer unit (a) represented by a following formula (1) based on a mass of the crystalline vinyl resin (A):

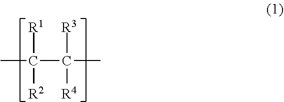

in the formula (1), at least two of R¹ to R⁴ are each independently —X—COOR⁵, and the remaining are each independently a hydrogen atom or an alkyl group having 1 to 4 carbon atoms, X is a single bond or an alkylene group having 1 or 2 carbon atoms, and R⁵ is an alkyl group having 16 to 30 carbon atoms,
the shell is an amorphous resin, and
where an SP value of the amorphous resin is SP_{S} (J/cm³)^{0.5} and an SP value of the crystalline vinyl resin (A) is SP_{A} (J/cm³)^{0.5} the SP_{S} and the SP_{A} satisfy |SP_{S}−SP_{A}|≤5.0.

According to at least one aspect of the present disclosure, there is provided a toner that contains a crystalline vinyl resin, which has excellent low-temperature fixability and heat-resistant storage stability, and that is less likely to exhibit changes in charging performance even in an environment where significant changes in temperature and humidity occur.

Further features of the present invention will become apparent from the following description of exemplary embodiments with reference to the attached drawings.

### BRIEF DESCRIPTION OF THE DRAWINGS

FIG. 1 is a diagram of temperature and humidity changes in a heat cycle test simulating cargo ship transportation.

FIG. 2 is an example of sample attachment for viscoelasticity measurement.

### DESCRIPTION OF THE EMBODIMENTS

In the present disclosure, the descriptions of “XX or more and YY or less” or “XX to YY” representing numerical ranges mean numerical ranges including the lower and upper limits, which are endpoints, unless otherwise specified. When numerical ranges are stated stepwise, the upper and lower limits of each numerical range can be combined arbitrarily.

In the present disclosure, a (meth)acrylic acid ester means an acrylic acid ester and/or a methacrylic acid ester.

In addition, in the present disclosure, wording such as “at least one selected from the group consisting of XX, YY and ZZ” means any of: XX; YY; ZZ; a combination of XX and YY; a combination of XX and ZZ; a combination of YY and ZZ; or a combination of XX and YY and ZZ.

The term “monomer unit” describes a reacted form of a monomeric material in a polymer. For example, one carbon-carbon bonded section in a principal chain of polymerized vinyl monomers in a polymer is given as one unit. A vinyl monomer can be represented by the following formula (3):

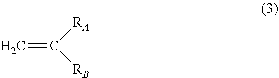

In formula (3), R_{A} represents a hydrogen atom or alkyl group (preferably a C₁₋₃ alkyl group, or more preferably a methyl group), and R_{B} represents any substituent.

A crystalline resin is a resin exhibiting a clear endothermic peak in differential scanning calorimetry (DSC) measurement.

In order to solve the problem, the inventors have studied the mechanism by which changes in charging performance occur when temperature and humidity changes occur. Although the binder resin of the toner particle is hard below the melting point or glass transition point thereof, it does not mean that there is no movement at all at the molecular level, and molecular motion can occur. This molecular motion becomes more active as the temperature increases. Also, it is common for resins to expand when the temperature is high and shrink when the temperature returns to normal.

In situations where temperature is not controlled, such as in sea transportation, large temperature changes from around 20° C. to around 60° C. can occur repeatedly, as mentioned above. This can lead to repeated occurrence of molecular movement, expansion, and contraction of the toner binder resin. The inventors recognized that when the affinity between the core of the toner particle and the shell that covers the core is high and above a certain level, the charging performance is likely to change when the particle is subjected to repeated large changes in temperature.

From these findings, the inventors inferred the following mechanism by which changes in charging performance occur. Where the toner repeatedly undergoes large changes in temperature and humidity, molecular movement of the resin in the toner particle and expansion and contraction of the resin occur. As this is repeated, when the core and shell have an affinity above a certain level, some of the resin molecules in the core and shell become entangled. It is considered that as a result, the phase separation between the shell, which was provided to improve the charging performance, and the core containing a crystalline vinyl resin, which has a problem with charging performance, becomes unclear, causing the charging performance to fluctuate.

It is considered that reducing the affinity between the core and shell is one approach to solve this problem. However, where the core and shell do not have a certain level of affinity, the core will easily peel off from the shell. Therefore, it is difficult to solve the problem by reducing the affinity because it would create another problem.

The inventors of the present invention conducted further studies to solve the above problem. It is considered that a second approach to prevent the crystalline vinyl resin molecules of the core and the amorphous resin molecules of the shell from becoming entangled is to restrict the movement of the resin molecules. However, restricting the movement of the resin molecules generally tends to be associated with the increase in melting point and glass transition point, which is likely to result in a trade-off with low-temperature fixability. For this reason, it was previously thought to be difficult to solve the problem by restricting the movement of the resin molecules.

Accordingly, the inventors conducted further studies on techniques for restricting the movement of the resin molecules while minimizing the impact on low-temperature fixability. As a result, the inventors found that the above problem can be solved by incorporating the crystalline vinyl resin (A) in the binder resin contained in the core and incorporating 5.0% by mass or more of the monomer unit (a) represented by formula (1) based on the mass of the crystalline vinyl resin (A). The inventors inferred the following with respect to the mechanism behind this solution.

The distance between side chains in the monomer unit (a) is less than that in crystalline vinyl resins containing acrylate structures having long-chain alkyl groups as side chains, which have been used in the conventional techniques. Where the distance between long-chain alkyl groups in the side chains in crystalline vinyl resins is small, the degree of freedom of the main chain and side chains is low, so that movement is relatively restricted. Therefore, it is considered that by introducing the monomer unit (a) into the crystalline vinyl resin (A), it is possible to restrict the movement of the main chain and side chains, and that the entanglement of the molecules of the core and shell can be suppressed even under large fluctuations in temperature. Meanwhile, the crystal density increases due to the monomer unit (a), but the crystallinity is not impaired, so that the effect on low-temperature fixability could be reduced to a minimum.

The inventors have therefore found out that, by using the following technique, it is possible to provide a toner including a crystalline vinyl resin with excellent low-temperature fixability and heat-resistant storage stability, the toner being resistant to changes in charging performance even in an environment where significant changes in temperature and humidity occur.

The present invention relates to a toner comprising a toner particle, wherein
the toner particle comprises
   a core comprising a binder resin, and
   a shell covering the core,
the binder resin comprises a crystalline vinyl resin (A),
the crystalline vinyl resin (A) comprises at least 5.0% by mass of a monomer unit (a) represented by a following formula (1) based on a mass of the crystalline vinyl resin (A):

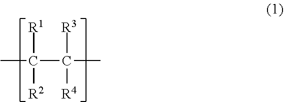

in the formula (1), at least two of R¹ to R⁴ are each independently —X—COOR⁵, and the remaining are each independently a hydrogen atom or an alkyl group having 1 to 4 carbon atoms, X is a single bond or an alkylene group having 1 or 2 carbon atoms, and R⁵ is an alkyl group having 16 to 30 carbon atoms,
the shell is an amorphous resin, and
where an SP value of the amorphous resin is SP_{S} (J/cm³)^{0.5} and an SP value of the crystalline vinyl resin (A) is SP_{A} (J/cm³)^{0.5}
the SP_{S} and the SP_{A} satisfy |SP_{S}−SP_{A}|≤5.0.

As a result of including the crystalline vinyl resin (A) in the binder resin, the toner can exhibit good heat-resistant storage stability and good low-temperature fixability. As mentioned above, it is considered that such effects can be obtained because the crystalline vinyl resin exhibits sharp melt property, that is, has a high storage elastic modulus up to the temperature required for heat-resistant storage stability, and shows sharp drop in the storage elastic modulus when heated to a temperature higher than that.

The crystalline vinyl resin (A) contains 5.0% by mass or more of the monomer unit (a) represented by formula (1) based on the mass of the crystalline vinyl resin (A).

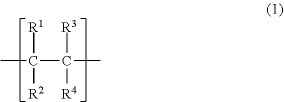

In formula (1), at least two of R¹ to R⁴ are each independently —X—COOR⁵, and the remaining are each independently hydrogen or an alkyl group having 1 to 4 carbon atoms. X represents a single bond or an alkylene group having 1 or 2 carbon atoms, and R⁵ represents an alkyl group having 16 to 30 carbon atoms.

As a result of the crystalline vinyl resin (A) containing 5.0% by mass or more of the monomer unit (a), the charging performance is unlikely to change even when the toner is transported in an environment where significant changes in temperature and humidity occur. The crystalline vinyl resin (A) contains preferably 30.0% by mass or more, and more preferably 45.0% by mass or more of the monomer unit (a).

Compared to the acrylate structure of the conventional techniques, the monomer unit (a) has a high density of the side chain —X—COOR⁵ that develops crystallinity. It is believed that this is why the effect of suppressing changes in charging performance can be exhibited.

The shell that covers the core is an amorphous resin. By using an amorphous resin as the shell, it is possible to improve low charge retention property inherent to the crystalline vinyl resins.

Furthermore, in the toner, where the SP value of the amorphous resin of the shell is SP_{S} (J/cm³)^{0.5} and the SP value of the crystalline vinyl resin (A) is SP_{A}(J/cm³)^{0.5}, SP_{S} and SP_{A} satisfy |SP_{S}−SP_{A}|≤5.0. The fact that the SP value is in the above range indicates that the affinity between the core and the shell is relatively high. |SP_{S}−SP_{A}| is preferably 0.0 to 5.0, more preferably 0.0 to 4.5, even more preferably 0.0 to 4.0, and still more preferably 2.0 to 4.0. It is also preferable that SP_{S}≤SP_{A}. |SP_{S}−SP_{A}| can be controlled by selecting the monomers used for the crystalline vinyl resin (A) and the amorphous resin.

Then affinity between the core and shell is required from the viewpoint of uniform coating and adhesion of the shell. By having |SP_{S}−SP_{A}| in the above range, the shell is uniformly coated and the charging performance and heat-resistant storage stability are good. Where |SP_{S}−SP_{A}| exceeds 5.0, the heat-resistant storage stability may decrease. Meanwhile, where |SP_{S}−SP_{A}| is in the above range and the affinity is high, the problem of changes in charging performance may arise. As described above, it is considered that the mechanism is that the molecular chains of the core and shell are easily entangled during repeated molecular motion due to the high affinity.
SP_{S} (J/cm³)^{0.5} is preferably 19.0 to 22.0, more preferably 19.5 to 21.5.
SP_{A} (J/cm³)^{0.5} is preferably 15.0 to 21.0, more preferably 16.0 to 18.0.

The toner will be described in detail below. The toner includes a toner particle. The toner particle may be used as it is as a toner, or may be used as a toner after mixing, as necessary, an external additive or the like and attaching it to the surface of the toner particle.

The toner particle has a core including a binder resin and a shell that covers the core. As necessary, the toner particle may include a release agent, a colorant, a charge control agent, and the like

### Binder Resin

The binder resin includes the crystalline vinyl resin (A). The crystalline vinyl resin (A) includes the monomer unit (a) represented by formula (1), and the content ratio thereof is 5.0% by mass or more based on the mass of the crystalline vinyl resin. By having the content ratio of the monomer unit (a) represented by formula (1) based on the mass of the crystalline vinyl resin (A) (hereinafter also referred to as ratio J) of 5.0% by mass or more, it is possible to obtain a toner that is less likely to exhibit changes in charging performance even when transported in an environment where significant changes in temperature and humidity occur.

The ratio J is preferably 30.0% by mass or more, and more preferably 45.0% by mass or more. For example, the ratio J is preferably 5.0% by mass to 90.0% by mass, more preferably 30.0% by mass to 90.0% by mass, and even more preferably 45.0% by mass to 85.0% by mass. The ratio J is preferably 0.7 mol % or more in terms of molar ratio. For example, the ratio J is more preferably 4.0 mol % to 40.0 mol %, and even more preferably 20.0 mol % to 35.0 mol % in terms of molar ratio. A method for introducing the monomer unit (a) into the crystalline vinyl resin will be described hereinbelow. The ratio J can be controlled by the amount of raw materials loaded when synthesizing the crystalline vinyl resin.

The crystalline vinyl resin (A) includes the monomer unit (a) represented by formula (1). In formula (1), at least two of R¹ to R⁴ are each independently —X—COOR⁵ (X is a single bond or an alkylene group having 1 or 2 carbon atoms, and R⁵ is an alkyl group having 16 to 30 carbon atoms), and the remaining are each independently a hydrogen atom or an alkyl group having 1 to 4 carbon atoms.

When such structure is satisfied, it is possible to provide a toner that includes a crystalline vinyl resin, which has excellent low-temperature fixability and heat-resistant storage stability, and that is less likely to exhibit changes in charging performance even in an environment where significant changes in temperature and humidity occur.

Where only one of R¹ to R⁴ satisfies —X—COOR⁵ and the remaining are each independently a hydrogen atom or an alkyl group having 1 to 4 carbon atoms, the density of the side chains is low, and the effect of suppressing changes in charging performance cannot be satisfactorily exhibited.

The preferred structures of the substituents are such that two of R¹ to R⁴ (more preferably one of R¹ and R² and one of R³ and R⁴) are each independently —X—COOR⁵ (X is a single bond or an alkylene group having 1 or 2 carbon atoms, R⁵ is an alkyl group having 16 to 30 carbon atoms), and the remaining are each independently a hydrogen atom or an alkyl group having 1 to 4 carbon atoms. Furthermore, it is more preferable that two of R¹ to R⁴ (more preferably one of R¹ and R² and one of R³ and R⁴) are each independently —X—COOR⁵ (X is a single bond or an alkylene group having 1 or 2 carbon atoms, R⁵ is an alkyl group having 16 to 30 carbon atoms), and the remaining are each independently a hydrogen atom or a methyl group. It is also preferable that X be a single bond.

R⁵ is an alkyl group having 16 to 30 carbon atoms. Where R⁵ is an alkyl group having 16 to 30 carbon atoms, the crystalline vinyl resin is more likely to exhibit crystallinity, and a toner having excellent low-temperature fixability can be obtained. In addition, heat-resistant storage stability is also improved. Where R⁵ has fewer than 16 carbon atoms, heat-resistant storage stability is likely to deteriorate, and where R⁵ has more than 30 carbon atoms, low-temperature fixability is more likely to deteriorate. R⁵ is preferably an alkyl group having 18 to 28 carbon atoms, and more preferably an alkyl group having 20 to 24 carbon atoms. The alkyl group of R⁵ is preferably linear.

The binder resin preferably contains 20.0% by mass or more of the crystalline vinyl resin (A) based on the mass of the binder resin (the content ratio of the crystalline vinyl resin (A) based on the mass of the binder resin is hereinafter also referred to as ratio I). Where the ratio I is 20.0% by mass or more, good low-temperature fixability can be obtained. The ratio I is more preferably 20.0% by mass to 70.0% by mass, and even more preferably 40.0% by mass to 60.0% by mass. The ratio I can be controlled by the amount of the crystalline vinyl resin (A) and the amount of other materials loaded when the toner particles are produced.

Furthermore, where the temperature at which the storage elastic modulus G′ of the toner becomes 1.0×10⁸ Pa is T1 (° C.) in viscoelasticity measurement of the toner, T1 preferably satisfies 40.0≤T1≤70.0. Where T1 is in the above range, the problem of changes in charging performance is more likely to occur. The fact that T1 is in the above range indicates that the elasticity of the toner begins to decrease in the temperature range of 40.0° C. to 70.0° C. Therefore, it is considered that the problem of changes in charging performance is more likely to occur in an environment where significant changes in temperature and humidity occur.

T1 (° C.) is more preferably 50.0 to 65.0. T1 (° C.) can be controlled by the molecular weight of the binder resin, crosslinking thereof, and the like.

Furthermore, in addition to the monomer unit (a), the crystalline vinyl resin (A) may or may not contain a monomer unit having an alkyl group with 16 to 30 carbon atoms that is different from the monomer unit (a). In the crystalline vinyl resin (A), the content ratio of the monomer unit (a) among the monomer units having an alkyl group with 16 to 30 carbon atoms, including the monomer unit (a) (hereinafter also referred to as ratio K), is preferably 50.0% by mass to 100.0% by mass, more preferably 75.0% by mass to 100.0% by mass, and even more preferably from 90.0% by mass to 100.0% by mass.

Where the ratio K is in the above range, it is possible to further suppress changes in charging performance occurring when the toner is transported in an environment where significant changes in temperature and humidity occur. The ratio K of 50.0% by mass or more indicates that there are many segments with high density of side chains, and it is considered that this restricts the movement of the resin molecules, making it possible to further suppress changes in the charging performance. The ratio K can be controlled by the amount of raw materials loaded when synthesizing the crystalline resin (A).

A method for introducing the monomer unit (a) represented by formula (1) into the crystalline vinyl resin (A) is to use a polymerizable ester, which is a condensation product of a polyvalent carboxylic acid having 4 to 6 carbon atoms and a carbon-carbon double bond with a monoalcohol having 16 to 30 carbon atoms and a chain-like hydrocarbon group, as a polymerizable monomer. The monomer unit (a) of formula (1) may be used alone or in combination of two or more types.

Examples of polyvalent carboxylic acids having 4 to 6 carbon atoms and a carbon-carbon double bond include maleic acid, fumaric acid, citraconic acid, mesaconic acid, itaconic acid, glutaconic acid, trans-aconitic acid, cis-aconitic acid, and the like. Furthermore, acid anhydrides and lower alkyl (1 to 4 carbon atoms) esters (for example, methyl ester, ethyl ester, isopropyl ester, and the like) of these polyvalent carboxylic acids may be used. The polyvalent carboxylic acids may be used alone or in combination of two or more. Among these, at least one selected from the group consisting of maleic acid, fumaric acid, itaconic acid, and acid anhydrides thereof is preferred. More preferably, at least one selected from the group consisting of maleic acid, fumaric acid, and acid anhydrides thereof is preferred.

Examples of monoalcohols having 16 to 30 carbon atoms and a chain hydrocarbon group include alcohols having a linear alkyl group (alkyl group having 16 to 30 carbon atoms) (cetanol, stearyl alcohol, 1-eicosanol, behenyl alcohol, 1-tetracosanol, 1-triacontanol, and the like) and alcohols having a branched alkyl group (alkyl group having 16 to 30 carbon atoms) (2-decyl-1-tetradecanol, and the like). Among these, from the viewpoint of crystallinity, alcohols having a linear alkyl group (alkyl group having 16 to 30 carbon atoms) are preferred. More preferred are alcohols having a linear alkyl group (alkyl group having 18 to 28 carbon atoms), and even more preferred are alcohols having a linear alkyl group (alkyl group having 20 to 24 carbon atoms).

A method for producing the polymerizable ester is not particularly limited, provided that a polyvalent carboxylic acid having 4 to 6 carbon atoms and a carbon-carbon double bond is condensed with a monoalcohol having 16 to 30 carbon atoms and a chain hydrocarbon group. It is preferable to use an esterification catalyst or a stabilizer (polymerization inhibitor) to carry out reliable condensation reaction and to prevent the reaction of the carbon-carbon double bond during the production of the polymerizable ester.

The acid value of the crystalline vinyl resin (A) is preferably 3.0 mgKOH/g or less from the viewpoint of further improving the low-temperature fixability and further suppressing changes in charging performance occurring when the toner is transported in an environment where significant changes in temperature and humidity occur. The acid value of the crystalline vinyl resin (A) is more preferably 0.0 mgKOH/g to 1.0 mgKOH/g, and even more preferably 0.2 mgKOH/g to 1.0 mgKOH/g. An acid value of 3.0 mgKOH/g or less indicates that there are few unreacted segments when synthesizing the crystalline vinyl resin (A). In other words, it is considered that the crystal density is high because there are few segments to which the monoalcohol is not attached. The acid value can be controlled within the above range by the ratio of carboxylic acid to alcohol when synthesizing the crystalline resin.

The crystalline vinyl resin (A) may contain other monomer units in addition to the monomer unit (a) represented by formula (1). The crystalline vinyl resin (A) may have a plurality of other monomer units. A method for introducing other monomer units is to polymerize the above-mentioned polymerizable ester with other vinyl monomers. The crystalline vinyl resin (A) is preferably a polymer of the above-mentioned polymerizable ester with other vinyl monomers.

Examples of other vinyl monomers include the following.

Styrene, α-methylstyrene, and (meth)acrylic acid esters such as methyl (meth)acrylate, ethyl (meth)acrylate, n-butyl (meth)acrylate, t-butyl (meth)acrylate, and 2-ethylhexyl (meth)acrylate.

Monomers having a urea group: for example, monomers obtained by reacting an amine having 3 to 22 carbon atoms [primary amines (such as normal butylamine, t-butylamine, propylamine, and isopropylamine), secondary amines (such as di-normal ethylamine, di-normal propylamine, and di-normal butylamine), aniline, cycloxylamine, and the like] with an isocyanate having 2 to 30 carbon atoms and an ethylenically unsaturated bond by a known method.

Monomers having a carboxy group: for example, methacrylic acid, acrylic acid, and 2-carboxyethyl (meth)acrylate.

Monomers having a hydroxy group: for example, 2-hydroxyethyl (meth)acrylate, 2-hydroxypropyl (meth)acrylate, and the like.

Monomers having an amide group: for example, acrylamide, and monomers obtained by reacting an amine having 1 to 30 carbon atoms with a carboxylic acid having 2 to 30 carbon atoms and an ethylenically unsaturated bond (such as acrylic acid and methacrylic acid) by a known method.

Monomers having a lactam structure; for example, N-vinyl-2-pyrrolidone.

Among these, it is preferred that the crystalline vinyl resin (A) include, in addition to the monomer unit (a), a monomer unit (b) different from the monomer unit (a). Where the SP value of the monomer unit (a) is SPa (J/cm³)^{0.5} and the SP value of the monomer unit (b) is SPb (J/cm³)^{0.5}, it is preferred that the following formula (2) be satisfied. However, where there are two or more types of other monomer units used in addition to the monomer unit (a) represented by formula (1), among these additional monomer units, the monomer unit that has a largest difference in SP value with the monomer unit (a) is selected as the monomer unit (b).

$$3. \leq \vert SPb - SPa \vert \leq 21. . \qquad ( 2 )$$

Where the relationship between the SP value SPa of the monomer unit (a) and the SP value SPb of the monomer unit (b) is within the above range, changes in charging performance can be further suppressed even when the material is transported in an environment where significant changes in temperature and humidity occur. It is considered that where the above |SPb −SPa| is satisfied, the crystalline segments and amorphous segments in the crystalline vinyl resin (A) tend to form a clear phase separation state, which further increases the density of the crystalline segments and makes it possible to further suppress molecular motion. It is more preferable that the relationship between SPa and SPb satisfy formula (4).

$$7. \leq \vert SPb - SPa \vert \leq 12. . \qquad ( 4 )$$

It is preferable that the crystalline vinyl resin (A) include a monomer unit corresponding to methacrylonitrile. The crystalline vinyl resin (A) preferably includes 1.0% by mass to 25.0% by mass, and more preferably 10.0% by mass to 20.0% by mass of a monomer unit corresponding to methacrylonitrile.

The crystalline vinyl resin (A) also preferably includes a monomer unit corresponding to styrene. The crystalline vinyl resin (A) preferably includes 1.0% by mass to 60.0% by mass, and more preferably 4.0% by mass to 10.0% by mass of a monomer unit corresponding to styrene.

The crystalline vinyl resin (A) may be produced by any known method within the scope of the configuration of the present application, but it is preferable that the composition of polymerizable monomers containing the above-mentioned polymerizable ester be polymerized using an initiator or the like.

A known polymerization initiator can be used as the polymerization initiator.

Examples of the polymerization initiator include azo or diazo polymerization initiators such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile; and peroxide polymerization initiators such as benzoyl peroxide, t-butyl peroxy-2-ethylhexanoate, t-butyl peroxypivalate, t-butyl peroxyisobutyrate, t-butyl peroxyneodecanoate, methyl ethyl ketone peroxide, diisopropyl peroxycarbonate, cumene hydroperoxide, 2,4-dichlorobenzoyl peroxide, and lauroyl peroxide.

Furthermore, known chain transfer agents and polymerization inhibitors may be used.

The binder resin may include an amorphous vinyl resin (B) in addition to the crystalline vinyl resin (A).

Examples of polymerizable monomers that can be used in the amorphous vinyl resin (B) include styrene derivatives such as α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene,
(meth)acrylic acid esters such as methyl (meth)acrylate, ethyl (meth)acrylate, butyl (meth)acrylate (n-butyl (meth)acrylate, t-butyl (meth)acrylate, and the like), and 2-ethylhexyl (meth)acrylate, and
acrylonitrile, methacrylonitrile, (meth)acrylic acid, and the like.

The amorphous vinyl resin (B) is preferably a polymer of a monomer mixture containing styrene and butyl (meth)acrylate.

The content ratio of the amorphous vinyl resin (B) is preferably 30.0% by mass to 80.0% by mass, more preferably 40.0% by mass to 60.0% by mass based on the mass of the binder resin.

### Release Agent

The toner particle may include a release agent. The release agent is preferably at least one selected from the group consisting of hydrocarbon waxes and ester waxes. By using a hydrocarbon wax and/or an ester wax, effective release properties can be easily ensured. The release agent more preferably contains an ester wax.

There are no particular limitations on the hydrocarbon wax, but examples include the following.

Aliphatic hydrocarbon waxes: low-molecular-weight polyethylene, low-molecular-weight polypropylene, low-molecular-weight olefin copolymer, Fischer-Tropsch wax, or waxes obtained by oxidizing these or adding an acid thereto.

The ester wax may have at least one ester bond in one molecule and may be either a natural ester wax or a synthetic ester wax.

There are no particular limitations on the ester wax, and examples thereof include the following:
esters of monohydric alcohols and monocarboxylic acids, such as behenyl behenate, stearyl stearate, and palmityl palmitate;
esters of dihydric carboxylic acids and monoalcohols, such as dibehenyl sebacate;
esters of dihydric alcohols and monocarboxylic acids, such as ethylene glycol distearate and hexanediol dibehenate;
esters of trihydric alcohols and monocarboxylic acids, such as glycerin tribehenate;
esters of tetrahydric alcohols and monocarboxylic acids, such as pentaerythritol tetrastearate and pentaerythritol tetrapalmitate;
esters of hexahydric alcohols and monocarboxylic acids, such as dipentaerythritol hexastearate, dipentaerythritol hexapalmitate, and dipentaerythritol hexabehenate;
esters of polyfunctional alcohols and monocarboxylic acids, such as polyglycerin behenate; and
natural ester waxes, such as carnauba wax and rice wax.

Among these, esters of hexahydric alcohols and monocarboxylic acids, such as dipentaerythritol hexastearate, dipentaerythritol hexapalmitate, and dipentaerythritol hexabehenate, and esters of octahydric alcohols and monocarboxylic acids, such as tripentaerythritol octastearate, tripentaerythritol octapalmitate, and tripentaerythritol octabehenate, are preferred.

In the toner, the content of the release agent in the toner particle is preferably from 1.0% by mass to 30.0% by mass, more preferably from 2.0% by mass to 25.0% by mass. Where the content of the release agent in the toner particle is within the above range, the releasability during fixing is easily ensured.

The melting point of the release agent is preferably from 60° C. to 120° C. Where the melting point of the release agent is within the above range, the release agent melts during fixing and easily out-migrates to the surface of the toner particle, making it easier to exhibit releasability. The melting point is more preferably from 70° C. to 100° C.

### Colorant

The toner particle may contain a colorant. Examples of colorants include known organic pigments, organic dyes, inorganic pigments, carbon black as a black colorant, magnetic particles, and the like. In addition, colorants that have been used in the conventional toners may be used.

Examples of yellow colorants include the following. Condensed azo compounds, isoindolinone compounds, anthraquinone compounds, azo metal complexes, methine compounds, and allylamide compounds. Specifically, C. I. Pigment Yellow 12, 13, 14, 15, 17, 62, 74, 83, 93, 94, 95, 109, 110, 111, 128, 129, 147, 155, 168, and 180 are preferably used.

Examples of magenta colorants include the following. Condensed azo compounds, diketopyrrolopyrrole compounds, anthraquinone compounds, quinacridone compounds, basic dye lake compounds, naphthol compounds, benzimidazolone compounds, thioindigo compounds, and perylene compounds. Specifically, C. I.

Pigment Red 2, 3, 5, 6, 7, 23, 48:2, 48:3, 48:4, 57:1, 81:1, 122, 144, 146, 166, 169, 177, 184, 185, 202, 206, 220, 221, 254 are preferably used.

Examples of cyan colorants include the following. Copper phthalocyanine compounds and derivatives thereof, anthraquinone compounds, and basic dye lake compounds. Specifically, C. I. Pigment Blue 1, 7, 15, 15:1, 15:2, 15:3, 15:4, 60, 62, 66 are preferably used.

Colorants are selected from the viewpoints of hue angle, chroma, lightness, lightfastness and tinting strength. The content of the colorant is preferably from 1.0 part by mass to 20.0 parts by mass per 100.0 parts by mass of the binder resin. Where magnetic particles are used as the colorant, the content thereof is preferably from 40.0 parts by mass to 150.0 parts by mass per 100.0 parts by mass of the binder resin.

### Charge Control Agent

The toner particle may contain a charge control agent as necessary. In addition, the charge control agent may be added externally to the toner particle. By blending the charge control agent, the charge characteristics can be stabilized, and it becomes possible to control the optimal charge quantity according to the development system.

As the charge control agent, a known charge control agent can be used, and a charge control agent that has a particularly fast charging speed and can stably maintain a constant charge quantity is preferable.

Examples of charge control agents that control the toner to negative chargeability include the following.

Organometallic compounds and chelating compounds are effective, and examples thereof include monoazo metallic compounds, acetylacetone metallic compounds, aromatic hydroxycarboxylic acids, aromatic dicarboxylic acids, and hydroxycarboxylic acid and dicarboxylic acid-based metallic compounds.

Examples of charge control agents that control the toner to positive chargeability include the following.

Nigrosine, quaternary ammonium salts, metallic salts of higher fatty acids, diorganotin borates, guanidine compounds, and imidazole compounds.

The content of the charge control agent is preferably from 0.01 parts by mass to 20.0 parts by mass, and more preferably from 0.5 parts by mass to 10.0 parts by mass with respect to 100.0 parts by mass of the toner particles.

### Shell

The toner particle has a shell that covers the core. The shell is an amorphous resin. By using an amorphous resin for the shell, it is possible to improve the charge retention property, which is a problem with crystalline resins.

There are no particular restrictions on the amorphous resin to be used in the shell layer, as long as the amorphous resin satisfies |SP_{S}−SP_{A}|≤5.0, and a known amorphous resin can be used. Specific examples include polyester resins, polyurethane resins, polyamide resins, vinyl resins, and the like. Among these, from the viewpoint of charge retention property, the shell preferably includes at least one selected from the group consisting of amorphous polyester resins and amorphous vinyl resins. It is more preferable that the shell include an amorphous polyester resin.

The polyester resin can be obtained by reacting a divalent or higher polyvalent carboxylic acid with a polyhydric alcohol.

Examples of the polyvalent carboxylic acid include the following compounds. Dibasic acids such as succinic acid, adipic acid, sebacic acid, phthalic acid, isophthalic acid, terephthalic acid, malonic acid, and dodecenylsuccinic acid, and anhydrides thereof or lower alkyl esters thereof, and aliphatic unsaturated dicarboxylic acids such as maleic acid, fumaric acid, itaconic acid, and citraconic acid. 1,2,4-benzenetricarboxylic acid, 1,2,5-benzenetricarboxylic acid, and anhydrides thereof or lower alkyl esters thereof. These may be used alone or in combination of two or more.

The polyhydric alcohols include the following compounds:

Alkylene glycols (ethylene glycol, 1,2-propylene glycol, and 1,3-propylene glycol); alkylene ether glycols (polyethylene glycol and polypropylene glycol); alicyclic diols (1,4-cyclohexanedimethanol); bisphenols (bisphenol A); and alkylene oxide (ethylene oxide and propylene oxide) adducts of alicyclic diols or bisphenols.

The alkyl portion of the alkylene glycol and alkylene ether glycol may be linear or branched. Further examples include glycerin, trimethylolethane, trimethylolpropane, pentaerythritol, and the like. These may be used alone or in combination of two or more. For the purpose of adjusting the acid value and hydroxyl value, monovalent acids such as acetic acid and benzoic acid, and monohydric alcohols such as cyclohexanol and benzyl alcohol may also be used as necessary.

There is no particular restriction on the method for producing polyester resin, and for example, transesterification and direct polycondensation can be used alone or in combination.

Preferably, polyester resin is produced at a polymerization temperature between 180° C. and 230° C. If necessary, the reaction system may be decompressed, and the water and alcohol generated during condensation are preferably removed while the reaction is carried out. Where the monomer is not soluble or compatible at the reaction temperature, a high-boiling point solvent may be added as a dissolution aid to dissolve the monomer. The polycondensation reaction is carried out while distilling off the dissolution aid. Where a monomer with low compatibility is present in the copolymerization reaction, it is preferable to condense the monomer with the low compatibility and the acid or alcohol, which are to be condensation polymerized with this monomer, beforehand, and then perform condensation polymerization with the main component.

Examples of catalysts that can be used in the production of polyester include the following. Titanium catalysts such as titanium tetraethoxide, titanium tetrapropoxide, titanium tetraisopropoxide, and titanium tetrabutoxide. Tin catalysts such as dibutyltin dichloride, dibutyltin oxide, and diphenyltin oxide.

The amorphous vinyl resin is preferably a synthetic resin with a main chain bonded by vinyl polymerization. For example, polystyrene or the like is preferred. Examples of polymerizable monomers used in amorphous vinyl resins include styrene derivatives such as α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene;
(meth)acrylic acid esters such as methyl (meth)acrylate, ethyl (meth)acrylate, n-butyl (meth)acrylate, t-butyl (meth)acrylate, and 2-ethylhexyl (meth)acrylate; and
acrylonitrile, methacrylonitrile, (meth)acrylic acid, and the like.

It is also preferable that the amorphous vinyl resin does not contain the monomer unit (a) represented by formula (1).

The shell may contain two or more types of amorphous resin. In that case, the SP_{S} is the SP value of the amorphous resin with the largest content.

The content of the amorphous resin in the shell is preferably from 0.1 parts by mass to 40.0 parts by mass, more preferably from 0.2 parts by mass to 30.0 parts by mass, even more preferably from 0.4 parts by mass to 25.0 parts by mass, still more preferably from 3.8 parts by mass to 10.0 parts by mass, and particularly preferably from 5.5 parts by mass to 8.0 parts by mass, with respect to 100 parts by mass of the binder resin.

In an image of the cross section of the toner observed with a transmission electron microscope (TEM), it is preferable that the shell be observed over 70.0% or more of the outer periphery of the core (the proportion of the outer periphery of the core over which the shell is observed is hereinafter also referred to as the coverage ratio). The coverage ratio is more preferably 90.0% or more. The coverage ratio is preferably, for example, 70.0% to 100.0%, and more preferably 90.0% to 99.0%. When the coverage ratio is within the above range, the effect of improving the charging performance is particularly good. This is thought to be because the periphery of the core containing the crystalline resin that easily leaks charge can be sufficiently covered with the amorphous resin that does not easily leak charge. The coverage ratio of the shell can be controlled by the amount and method of addition of the material that forms the shell.

In addition, in an image of the cross section of the toner observed with a transmission electron microscope (TEM), it is preferable that the toner particle further has a second shell that covers the shell of the amorphous resin and is different from the shell of the amorphous resin. Due to the presence of the second shell, the charging performance is less likely to change even during long-term transportation. It is more preferable that the second shell contain an organosilicon polymer or a melamine resin. It is even more preferable that the second shell be an organosilicon polymer. The organosilicon polymers are resistant to heat and are particularly less likely to change the charging performance even during long-term transportation. For the same reason, melamine resin is also preferable as the second shell. As the melamine resin, for example, a polymer of methylolmelamine such as hexamethylolmelamine can be used.

A method for forming the organosilicon polymer shell is not particularly limited, and any known method can be used. For example, a sol-gel method can be mentioned. The sol-gel method is a method in which a liquid raw material is used as a starting material, hydrolysis and condensation polymerization are performed, and the material is gelled after passing through a sol state. This method is used for synthesizing glass, ceramics, organic-inorganic hybrids, and nanocomposites. By using this manufacturing method, functional materials of various shapes such as surface layers, fibers, bulk bodies, and fine particles can be produced at low temperatures from a liquid phase. The organosilicon polymer shell is preferably produced by hydrolysis and condensation polymerization of a silicon compound such as an alkoxysilane.

The organosilicon polymer is preferably a condensation polymer of an organosilicon compound having a structure represented by the following formula (Y).

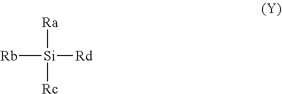

In formula (Y), Ra represents a hydrocarbon group having 1 to 6 carbon atoms (preferably an alkyl group having 1 to 6 carbon atoms), and Rb, Rc, and Rd each independently represent a halogen atom, a hydroxy group, an acetoxy group, or an alkoxy group.

Ra is preferably an aliphatic hydrocarbon group having 1 to 3 carbon atoms, and more preferably a methyl group.

Rb, Rc, and Rd each independently represent a halogen atom, a hydroxy group, an acetoxy group, or an alkoxy group (hereinafter also referred to as a reactive group). These reactive groups undergo hydrolysis, addition polymerization, and condensation polymerization to form a crosslinked structure.

From the standpoints of mild hydrolysis at room temperature and deposition onto the surface of toner particle, an alkoxy group having 1 to 3 carbon atoms is preferable, and a methoxy group or an ethoxy group is more preferable.

Furthermore, the hydrolysis, addition polymerization, and condensation polymerization of Rb, Rc, and Rd can be controlled by the reaction temperature, reaction time, reaction solvent, and pH. To obtain an organosilicon polymer, one or a combination of a plurality of organosilicon compounds that have three reactive groups (Rb, Rc, and Rd) in one molecule, excluding Ra in the above formula (Y), may be used. Such compounds hereinafter are also referred to as trifunctional silanes.

Examples of compounds represented by the above formula (Y) include the following: Trifunctional methylsilanes such as methyltrimethoxysilane, methyltriethoxysilane, methyldiethoxymethoxysilane, methylethoxydimethoxysilane, methyltrichlorosilane, methylmethoxydichlorosilane, methylethoxydichlorosilane, methyldimethoxychlorosilane, methylmethoxyethoxychlorosilane, methyldiethoxychlorosilane, methyltriacetoxysilane, methyldiacetoxymethoxysilane, methyldiacetoxyethoxysilane, methylacetoxydimethoxysilane, methylacetoxymethoxyethoxysilane, methylacetoxydiethoxysilane, methyltrihydroxysilane, methylmethoxydihydroxysilane, methylethoxydihydroxysilane, methyldimethoxyhydroxysilane, methylethoxymethoxyhydroxysilane, and methyldiethoxyhydroxysilane.

Among these, the compound represented by formula (Y) is preferably methyltrimethoxysilane or methyltriethoxysilane, and more preferably methyltriethoxysilane. The content of the second shell is preferably from 1.0 parts by mass to 10.0 parts by mass, more preferably from 2.0 parts by mass to 8.0 parts by mass, and even more preferably from 3.0 parts by mass to 5.0 parts by mass, relative to 100 parts by mass of the binder resin.

### Production Method of Toner Particle

A production method of toner particle is not particularly limited. Any known method such as suspension polymerization method, emulsion aggregation method, dissolution suspension method, and pulverization method may be adopted, but it is preferable that the toner particle be produced by the suspension polymerization method. It is preferable that the toner particle be a suspension-polymerized toner particle. The suspension polymerization method will be described in detail.

For example, the crystalline vinyl resin (A) synthesized in advance is added to a mixture of polymerizable monomers that produces, for example, an amorphous vinyl resin (B). If necessary, other materials such as a colorant, a release agent, and a charge control agent are added and uniformly dissolved or dispersed to prepare a polymerizable monomer composition.

Then, the polymerizable monomer composition is dispersed in an aqueous medium using a stirrer or the like to prepare suspended particles of the polymerizable monomer composition. The polymerizable monomers contained in the particles are then polymerized using an initiator or the like to obtain toner particles.

As an example of forming a shell on a toner particle by the suspension polymerization method, a highly hydrophilic amorphous resin is added to the raw materials, and during polymerization in water, the amorphous resin migrates to the surface layer of the toner particle and forms a shell.

In addition, when forming a second shell, it is preferable to form the second shell after forming a shell of amorphous resin. For example, a method of adding a hydrolysate of a silicon compound to an aqueous medium containing toner particles on which an amorphous resin shell has been formed and condensation-polymerizing the silicon compound to form the second shell can be used. Another example is a method of adding raw materials of a melamine resin to an aqueous medium containing toner particles on which an amorphous resin shell has been formed and generating a melamine resin to form the second shell.

The toner particles may be filtered, washed, and dried by known methods. Furthermore, an external additive may be added as necessary to obtain a toner.

The aqueous medium may contain an inorganic or organic dispersion stabilizer. Known dispersion stabilizers can be used as the dispersion stabilizer.

Examples of inorganic dispersion stabilizers include phosphates such as hydroxyapatite, tricalcium phosphate, dicalcium phosphate, magnesium phosphate, aluminum phosphate, and zinc phosphate; carbonates such as calcium carbonate and magnesium carbonate; metal hydroxides such as calcium hydroxide, magnesium hydroxide, and aluminum hydroxide; sulfates such as calcium sulfate and barium sulfate; calcium metasilicate; bentonite; silica; and alumina.

Meanwhile, examples of organic dispersion stabilizers include polyvinyl alcohol, gelatin, methyl cellulose, methylhydroxypropyl cellulose, ethyl cellulose, sodium salt of carboxymethyl cellulose, polyacrylic acid and salts thereof, and starch.

Where an inorganic compound is used as a dispersion stabilizer, a commercially available product may be used as is, but in order to obtain finer particles, the inorganic compound formed in an aqueous medium may be used.

For example, in the case of calcium phosphate such as hydroxyapatite or tricalcium phosphate, an aqueous phosphate solution and an aqueous calcium salt solution may be mixed under high agitation.

The aqueous medium may contain a surfactant. As the surfactant, a known surfactant may be used. For example, anionic surfactants such as sodium dodecylbenzene sulfate and sodium oleate; cationic surfactants; amphoteric surfactants; nonionic surfactants, and the like may be mentioned.

### External Additive

The toner particles may be used as a toner as is or may be made into a toner by mixing with an external additive and the like, as necessary, and attaching the external additive to the surface of the toner particle.

Examples of external additives include inorganic fine particles selected from the group consisting of silica fine particles, alumina fine particles, and titania fine particles, or composite oxides thereof. For example, composite oxides include silica aluminum fine particles and strontium titanate fine particles.

The content of the external additive is preferably from 0.01 parts by mass to 8.0 parts by mass, and more preferably from 0.1 parts by mass to 4.0 parts by mass, per 100 parts by mass of the toner particles.

The calculation and measurement methods for various physical properties of the toner and toner materials are described below.

Method for Separating Toner Particle from Toner

When analyzing toner particle, where the surface of the toner particle is treated with an external additive or the like, the external additive is separated by the following method to obtain the toner particle.

A total of 160 g of sucrose (manufactured by Kishida Chemical Co., Ltd.) is added to 100 mL of ion-exchanged water and dissolved while heating in a hot water bath to prepare a concentrated sucrose solution. A total of 31 g of the concentrated sucrose solution and 6 mL of Contaminon N (a 10% by mass aqueous solution of a neutral detergent for cleaning precision measuring instruments with a pH of 7 consisting of a nonionic surfactant, an anionic surfactant, and an organic builder, manufactured by Wako Pure Chemical Industries, Ltd.) is placed in a centrifuge tube to prepare a dispersion liquid.

Then, 1.0 g of toner is added to this dispersion liquid and the toner lumps are broken up with a spatula or the like. The centrifuge tube is shaken at 350 spm (strokes per minute) for 20 min in a shaker (AS-1N, marketed by AS ONE Corporation). After shaking, the solution is transferred to a glass tube (50 mL) for a swing rotor, and separation is performed in a centrifuge (H-9R, manufactured by KOKUSAN Co., Ltd.) at 3,500 rpm for 30 min. This operation separates the toner particles from the external additive that has been removed.

Sufficient separation of the toner particles and the aqueous solution is visually confirmed, and the toner particles that have separated to the top layer are collected with a spatula or the like. The collected toner is filtered with a vacuum filter and then dried in a dryer for at least 1 h to obtain toner particles. This operation is carried out multiple times to ensure the required amount.

### Method for Separating Tetrahydrofuran (THF) Insoluble Matter

Separation of THF insoluble matter from toner particles is performed according to the following procedure. A total of 1.5 g of toner particles from which a THF insoluble matter is to be separated is accurately weighed (W [g]) (0.7 g when measuring the THF insoluble matter of the resin alone) and placed in a pre-weighed cylindrical filter paper (product name: No. 86R, size 28×100 mm, manufactured by Advantec Toyo Co., Ltd.) which is then set in a Soxhlet extractor.

Extraction is performed for 18 h using 200 mL of tetrahydrofuran (THF) as a solvent. At this time, the extraction is performed at a reflux rate such that the solvent extraction cycle occurs once every 5 min.

After the extraction is complete, the cylindrical filter paper is removed, air-dried, and then vacuum-dried at 40° C. for 8 h. The mass of the cylindrical filter paper containing the extraction residue is weighed, and the mass of the extraction residue (W2 [g]) is calculated by subtracting the mass of the cylindrical filter paper. Meanwhile, the mass of the matter soluble in THF (W1 [g]) is calculated by thoroughly distilling off the THF with an evaporator.

Method for Separating Crystalline Vinyl Resin (A) and Amorphous Resin from Toner Particle

Separation of the crystalline vinyl resin (A) and the amorphous resin from the toner particle can be achieved by known methods, an example of which is shown below.

Gradient LC is used as a method for separating resin components from toner particles. In this analysis, separation can be achieved according to the polarity of the resin in the binder resin, regardless of molecular weight.

First, the toner particles are dissolved in chloroform. The sample concentration is adjusted to 0.1% by mass in chloroform, and the solution is filtered through a 0.45 μm PTFE filter and used for measurement. The gradient polymer LC measurement conditions are shown below.
Apparatus: UltiMate 3000 (manufactured by Thermo Fisher Scientific Inc.)
Mobile phase: A chloroform (HPLC), B acetonitrile (HPLC)
Gradient: 2 min (A/B=0/100)→25 min (A/B=100/0)
(The gradient of the mobile phase change was set to be linear.)
Flow rate: 1.0 mL/min
Injection: 0.1% by mass×20 L
Column: Tosoh TSKgel ODS (4.6 mm diameter×150 mm×5 μm)
Column temperature: 40° C.
Detector: Corona Charged Aerosol Detector (Corona-CAD) (manufactured by Thermo Fisher Scientific Inc.)

The resin components can be separated into two peaks according to polarity in the time-intensity graph obtained by the measurement. After that, the above measurement is performed again, and separation into two types of resin can be performed by taking out the fractions at the time when the valleys of the respective peaks are reached. The separated resins are subjected to DSC measurement, and the resin with a melting point peak is taken as the crystalline vinyl resin (A) (mass W11 [g]), and the resin without a melting point peak is taken as the amorphous resin (mass W12 [g]).

Where the toner particle contains a release agent, it is necessary to separate the release agent from the toner particle in advance. In the separation of the release agent, the components with a molecular weight of 3000 or less are separated by recycling HPLC as the release agent. The molecular weight at the time of separation can be changed according to the molecular weight of the release agent. The measurement method is described hereinbelow.

First, a chloroform solution of the toner is prepared using the method described above. The resulting solution is then filtered through a solvent-resistant membrane filter “MyShori Disc” (manufactured by Tosoh Corporation) with a pore size of 0.2 μm to obtain a sample solution. The sample solution is adjusted so that the concentration of components soluble in chloroform is 1.0% by mass. This sample solution is used for measurements under the following conditions.
Apparatus: LC-Sakura NEXT (manufactured by Japan Analytical Industry Co., Ltd.)
Column: JAIGEL 2H, 4H (manufactured by Japan Analytical Industry Co., Ltd.)
Eluent: Chloroform
Flow rate: 10.0 ml/min
Oven temperature: 40.0° C.
Sample injection amount: 1.0 ml

To calculate the molecular weight of the sample, a molecular weight calibration curve created using standard polystyrene resins (for example, product names “TSK Standard Polystyrene F-850, F-450, F-288, F-128, F-80, F-40, F-20, F-10, F-4, F-2, F-1, A-5000, A-2500, A-1000, A-500”, manufactured by Tosoh Corporation) is used.

From the molecular weight curve thus obtained, components with a molecular weight of 3000 or less are repeatedly fractionated, and the release agent (mass W3 [g]) is removed from the toner particle.

Measurement Method of Differential Scanning Calorimetry (DSC) The presence or absence of crystalline resin and the endothermic peak temperature of the melting point are measured in accordance with ASTM D3418-82 using a differential scanning calorimetry analyzer “Q2000” (manufactured by TA Instruments). The melting points of indium and zinc are used for temperature correction of the device detection unit, and the heat of fusion of indium is used for heat correction.

The toner measurement is performed by, first, accurately weighing 10 mg of toner and placing it in an aluminum pan and using an empty aluminum pan as a reference. In the first temperature raising process, the temperature of the measurement sample is raised from 20° C. to 180° C. at 10° C./min while the measurement is performed, and differential scanning calorimetry curve A is obtained. After that, the material is held at 180° C. for 10 min, and then a cooling process is performed in which the material is cooled from 180° C. to 10° C. at 10° C./min while the measurement is performed to obtain a differential scanning calorimetric curve B. After that, the material is held at 10° C. for 10 min, and then in the second temperature raising process, the temperature is raised again from 10° C. to 180° C. at 10° C./min while the measurement is performed to obtain a differential scanning calorimetric curve C. The peak top temperature of the peak that appears in the obtained differential scanning calorimetric curve C is determined and is taken as the endothermic peak temperature of the melting point.

### MEASUREMENT of Content Ratio of Each Component in Toner Particle

The content ratio of each component in the toner particle is calculated in the following manner from the masses described in the above-mentioned <Method for Separating Tetrahydrofuran (THF) Insoluble Matter> and <Method for Separating Crystalline Vinyl Resin (A) and Amorphous Resin from Toner Particle>.
[Mass ratio of crystalline vinyl resin based on the mass of binder resin: Ratio I (unit: % by mass)]

$$I = ( W 11 / ( W 11 + W 12 ) ) \times 100$$

### Method for Measuring Content Ratio of Various Monomer Units Such as Monomer Unit (a) in Resin and the Number of Carbon Atoms in Alkyl Groups

The content ratio of various monomer units such as the monomer unit (a) in the resin and the number of carbon atoms in alkyl groups are measured by ¹H-NMR under the following conditions. The crystalline vinyl resin separated using the above method can be used as the measurement sample.
Measurement device: FT NMR device JNM-EX400 (manufactured by JEOL Ltd.)
Measurement frequency: 400 MHz
Pulse condition: 5.0 s
Frequency range: 10,500 Hz
Number of times of accumulation: 64
Measurement temperature: 30° C.

Sample: the sample is prepared by placing 50 mg of the measurement sample in a sample tube with an inner diameter of 5 mm, adding deuterated chloroform (CDCl₃) as a solvent, and dissolving the measurement sample in a thermostatic bath at 40° C. The obtained ¹H-NMR chart is analyzed to identify the structure of each monomer unit. As an example, the measurement of the content ratio of the monomer unit (a) in the crystalline vinyl resin and the number of carbon atoms of the alkyl groups is described herein. In the obtained ¹H-NMR chart, a peak that is independent of the peaks attributed to components of other monomer units is selected from the peaks that are attributed to the components of the monomer unit (a), and the integral value S1 of this peak is calculated. The integral values of the other monomer units contained in the crystalline vinyl resin are calculated in the same manner.

For example, where the monomer units constituting the crystalline vinyl resin are the monomer unit (a) and one other monomer unit, the content ratio of the monomer unit (a) is calculated as follows using the integral value S1 and the integral value S2 of the peak of the other monomer unit. Here, n1 and n2 are the numbers of hydrogen atoms in the components to which the peaks of interest for each segment belong.

$$Content ratio of the monomer unit ( a ) ( mol \% ) = \{ ( S 1 / n 1 ) / ( ( S 1 / n 1 ) + ( S 2 / n 2 ) ) \} \times 100$$

When there are two or more other monomer units, the content ratio of the monomer unit (a) can be also calculated in the same manner (using S3 . . . Sx, n3 . . . nx).

The number of carbon atoms in the alkyl group can be calculated from the integral ratio of proton peaks in the ¹H-NMR chart.

When a polymerizable monomer that does not contain hydrogen atoms in components other than the vinyl group is used, the measurement nucleus is set to ¹³C using ¹³C-NMR, measurement is performed in a single pulse mode, and calculation is performed in the same manner as in ¹H-NMR.

The proportion (mol %) of each monomer unit calculated by the above method is multiplied by the molecular weight of each monomer unit to convert the content ratio of each monomer unit to “% by mass”. In this way, the mass ratio J of the monomer unit (a) represented by the above formula (1) is calculated based on the mass of the crystalline vinyl resin.
[Content ratio of monomer unit (a) based on the mass of crystalline vinyl resin (A): Ratio J (unit: % by mass)]

$$J = \{ ( S 1 / n 1 ) \times M 1 / ( ( S 1 / n 1 ) \times M 1 + ( S 2 / n 2 ) \times M 2 ) \} \times 100$$

In addition, where a monomer unit having an alkyl group with 16 to 30 carbon atoms is present in addition to the monomer unit (a) represented by formula (1), the content ratio (ratio K) of the monomer unit (a) in the monomer units having an alkyl group with 16 to 30 carbon atoms is calculated as follows. For example, where the units having an alkyl group with 16 to 30 carbon atoms are the monomer unit (a) and one other monomer unit, the content ratio of the monomer unit (a) is calculated by the following formula using the integral value S1 and the integral value S3 of the peak of the other monomer unit.
[Mass ratio of monomer unit (a) in monomer units having an alkyl group with 16 to 30 carbon atoms: ratio K (unit: % by mass)]

$$Ratio K = \{ ( S 1 / n 1 ) \times M 1 / ( ( S 1 / n 1 ) \times M 1 \times ( S 3 / n 3 ) \times M 3 ) \} \times 100$$

Here, M1 and M3 are the molecular weights of the respective monomer units. The same method is used to perform measurement for the amorphous vinyl resins.

### Method for Calculating Solubility Parameters (SP Values)

The SP values are calculated as follows according to the calculation method proposed by Fedors.

First, the SP values of the monomer units that constitute the resin are calculated in the following manner. Here, the monomer unit that constitutes the resin refers to the molecular structure in the state in which the double bond of the monomer used when obtaining the resin by polymerization is cleaved by polymerization.

For example, when calculating the SP value (am) (J/cm³)^{0.5} of a monomer unit, the evaporation energy (Δei) (J/mol) and molar volume (Δvi) (cm³/mol) for the atom or atomic group in the molecular structure of the monomer unit are obtained from the table in “Polym. Eng. Sci., 14(2), 147-154 (1974)”, and calculation is performed using the following formula.

$$σ m = {( \sum Δ ei / \sum Δ vi )}^{0.5}$$

The SP value of a resin is calculated by calculating the evaporation energy (Δei) and molar volume (Δvi) of the monomer units that make up the resin for each monomer unit. Then, the product of each calculation result with the molar ratio (j) of each monomer unit in the resin is calculated, and the sum total of the evaporation energies of the monomer units is divided by the sum total of the molar volumes. The calculation is performed by the following formula.

$$σ p = {\{ ( \sum j \times \sum Δ ei ) / ( \sum j \times \sum Δ vi ) \}}^{0.5}$$

For example, assuming that a resin is composed of two types of monomer units, X and Y, where the composition ratio of each monomer unit is Wx and Wy (% by mass), the molecular weight is Mx and My, the evaporation energy is Δei(X) and Δei(Y), and the molar volume is Δvi(X) and Δvi(Y), then the molar ratio (j) of each monomer unit is Wx/Mx and Wy/My, respectively, and the SP value (σp) of this resin is given by the following formula.

$$σ p = {[ \{ ( Wx / M x ) \times Δ ei ( X ) + Wy / My \times Δ ei ( Y ) \} / \{ ( Wx / M x ) \times Δ vi ( X ) + Wy / My \times Δ vi ( Y ) \} ]}^{0.5}$$

Furthermore, when two or more types of resin are mixed, the SP value (σM) of the mixture is calculated as the product of the mass composition ratio (Wi) of the mixture and the SP value (σi) of each resin by the following formula.

$$σ M = \sum ( Wi \times σ i )$$

### Method for Calculating Shell Coverage Ratio and Observing Second Shell

The proportion of the toner shell observed (coverage ratio) can be obtained by measuring the cross-sectional shape of a single toner particle. The specific method for measuring the cross-sectional shape of a single toner particle is as follows.

First, the toner is sufficiently dispersed in a photocurable epoxy resin, and then the epoxy resin is cured by irradiation with ultraviolet light. The resulting cured product is cut using a microtome equipped with a diamond blade to prepare a thin flake-shaped sample with a thickness of 100 nm. After staining the sample with ruthenium tetroxide, a transmission electron microscope (TEM) (product name: electron microscope Tecnai TF20XT, manufactured by FEI Co.) is used to observe the cross-section of the toner at an acceleration voltage of 120 kV to obtain a TEM image. In this case, the cross-section having a major axis diameter of 0.9 to 1.1 times the number-average particle diameter (D1) of the same toner measured according to the method for measuring the number-average particle diameter (D1) of the toner described below is selected as the cross-section of the toner.

In the above observation method, the amorphous resin in the toner particle is strongly stained by ruthenium tetroxide. As a result, the shell portion, which is mainly composed of amorphous resin, is stained, and the core portion, which is mainly composed of unstained crystalline resin, can be observed in contrast therewith. The observation magnification is 20,000 times.

Based on the obtained TEM image, the length C1 (nm) of the portion of the length of the outer periphery (perimeter) of a toner particle where the shell is observed, and the length C2 (nm) of the outer periphery (perimeter) of a toner particle are calculated in the cross section of the toner particle, and C1/C2×100 (%) is taken as the shell coverage ratio (proportion where the shell is observed). This measurement is performed for 100 toner particles, and the arithmetic mean value is used.

Where a second shell is present, the presence of a shell on the outer periphery of the shell of the amorphous resin is observed.

### Identification of Second Shell

The second shell can be identified by performing elemental analysis of the toner particle surface. Examples where the second shell is an organosilicon polymer and where the second shell is a melamine resin will be explained hereinbelow.

### Method for Identifying Organosilicon Polymer

An organosilicon polymer can be identified by combining SEM observation and elemental analysis by EDS.

Using a scanning electron microscope “S-4800” (product name; manufactured by Hitachi, Ltd.), a toner particle is observed at a field of view magnified up to 50,000 times. EDS analysis is performed by focusing on the surface of the toner particle, and the presence or absence of an Si element peak is used to determine whether the surface is an organosilicon polymer.

Where both an organosilicon polymer and silica are contained, the organosilicon polymer is identified by comparing the ratio (Si/O ratio) of the elemental contents of Si and O (atomic %) with a standard.

EDS analysis is performed under the same conditions for each standard of the organosilicon polymer and silica to obtain the elemental contents of Si and O (atomic %).

The Si/O ratio of the organosilicon polymer is designated as A, and the Si/O ratio of the silica fine particles is designated as B. Measurement conditions are selected such that A is significantly greater than B.

Specifically, the standards are measured 10 times under the same conditions, and the respective arithmetic mean values A and B are obtained. Measurement conditions are selected such that the obtained mean value A/B>1.1.

Where the Si/O ratio of the particle to be identified is on the A side of [(A+B)/2], it is determined that the component is an organosilicon polymer.

Commercial standards of organosilicon polymers can be used. Tospearl 120A (Momentive Performance Materials Japan, LLC) is an example of a commercially available product thereof. For example, HDK V15 (Asahi Kasei Corporation) is an example of a commercially available silica standard.

### Method for Identifying Melamine

Melamine can also be identified in the same manner as the organosilicon polymer. A melamine standard is prepared, EDS analysis is performed on the standard and toner particle under the same conditions, and the melamine is identified based on the C to N ratio. A commercially available melamine resin product can also be used for the melamine standard. An example of a commercially available product is MM-A (Panasonic Industries Co., Ltd.).

### Method for Measuring Viscoelasticity

Measurement of viscoelasticity is performed using a viscoelasticity measuring device (rheometer) ARES (manufactured by Rheometric Scientific, Inc.).

The outline of the measurement is described in the ARES operation manuals 902-30004 (edition of August 1997) and 902-00153 (edition of July 1993) issued by Rheometric Scientific, Inc. and is as follows.
Measurement tool: torsion rectangular
Measurement sample: for the toner, a sample in the form of a rectangular parallelepiped with a width of 12 mm, height of 20 mm, and thickness of 2.5 mm is prepared using a pressure molding machine (25 kN is maintained for 30 min at room temperature). The pressure molding machine used is a 100 kN press NT-100H manufactured by NPa System Co., Ltd.

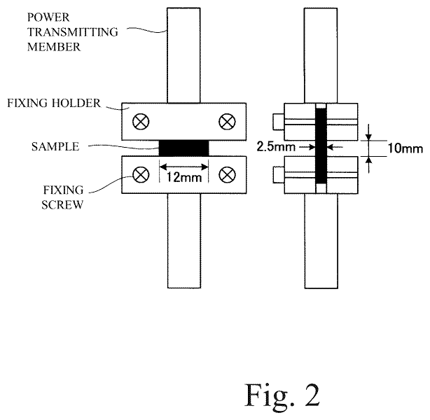

The jig and sample are allowed to stand at room temperature (23° C.) for 1 h, and the sample is then attached to the jig. See FIG. 2. As shown in the figure, the sample is fixed so that the measurement area has a width of 12.0 mm, a thickness of 2.5 mm, and a height of 10.0 mm. After regulating the temperature to 30° C. over 10 min, the measurement is performed with the following settings.
Measurement frequency: 6.28 rad/s
Measurement strain setting: the initial value is set to 0.1% and the measurement is performed in automatic measurement mode
Sample elongation correction: adjustment is performed in automatic measurement mode
Measurement temperature: the temperature is raised from 30° C. to 150° C. at a rate of 2° C. per minute
Measurement interval: viscoelasticity data are measured every 30 sec, i.e., every 1° C.

Data are transferred through an interface to RSI Orchestrator (control, data collection and analysis software) (manufactured by Rheometric Scientific, Inc.) running on Microsoft Windows (registered trademark) 2000.

The temperature at which the storage elastic modulus G′ of the measurement data becomes 1.0×10⁸ Pa is defined as T1 [° C.].

### Method for Measuring Acid Value

Acid value is the number of milligrams of potassium hydroxide required to neutralize an acid contained in 1 g of sample. The acid value of resin is measured according to JIS K 0070-1992, specifically, according to the following procedure.

(1) Preparation of Reagents

A total of 1.0 g of phenolphthalein is dissolved in 90 mL of ethyl alcohol (95% by volume), and ion-exchanged water is added to make 100 mL and obtain a phenolphthalein solution.

A total of 7 g of special grade potassium hydroxide is dissolved in 5 mL of water, and ethyl alcohol (95% by volume) is added to make 1 L. The solution is placed in an alkali-resistant container to avoid contact with carbon dioxide and the like, allowed to stand for 3 days, and then filtered to obtain a potassium hydroxide solution.

The obtained potassium hydroxide solution is stored in an alkali-resistant container. The factor of the potassium hydroxide solution is obtained by placing 25 mL of 0.1 mol/L hydrochloric acid in an Erlenmeyer flask, adding a few drops of the phenolphthalein solution, titrating with the potassium hydroxide solution, and determining the amount of potassium hydroxide solution required for neutralization. The 0.1 mol/L hydrochloric acid used is prepared in accordance with JIS K 8001-1998.

(2) Procedure

### (A) Main Test

A total of 2.0 g of a sample (for example, the crystalline vinyl resin (A)) is weighed out into a 200 mL Erlenmeyer flask, 100 mL of a toluene/ethanol (2:1) mixed solution is added, and dissolution is performed for 5 h.

Then, a few drops of the phenolphthalein solution is added as an indicator, and titration is performed using the potassium hydroxide solution. The end point of the titration is when the light red color of the indicator continues for 30 sec.

### (B) Blank Test

The titration is performed in the same manner as above, except that no sample is used (i.e., only a toluene/ethanol (2:1) mixed solution is used).

(3) The obtained results are substituted into the following formula to calculate the acid value.

$$A = [ ( C - B ) \times f \times 5.61 ] / S$$

Here, A is the acid value (mgKOH/g), B is the amount of potassium hydroxide solution added in the blank test (mL), C is the amount of potassium hydroxide solution added in the main test (mL), f is the factor of the potassium hydroxide solution, and S is the mass of the sample (g).

### Measurement of Number-Average Particle Diameter of Toner (D1)

The number-average particle diameter (D1) of toner is calculated as follows. The measuring device used is the “Coulter Counter Multisizer 3” (registered trademark, manufactured by Beckman Coulter, Inc.), a precision particle diameter distribution measuring device using a pore electrical resistance method and equipped with a 100 μm aperture tube. The measurement conditions are set, and the measurement data are analyzed using the dedicated software “Beckman Coulter Multisizer 3 Version 3.51” (manufactured by Beckman Coulter, Inc.) provided with the device. The measurements are performed with an effective measurement channel count of 25,000.

The electrolytic solution used for the measurements is made by dissolving special-grade sodium chloride in ion-exchange water to a concentration of 1.0%. For example, “ISOTON II” (manufactured by Beckman Coulter, Inc.) is used. Before performing measurements and analysis, the dedicated software is set up as follows.

In the “Change Standard Measurement Method (SOMME)” screen of the dedicated software, the total count number in the control mode is set to 50,000 particles, the number of measurements is set to 1, and the Kd value is set to the value obtained using “Standard Particle 10.0 μm” (manufactured by Beckman Coulter, Inc.). The threshold and noise level are automatically set by pressing the “Threshold/Noise Level Measurement Button”. In addition, the current is set to 1,600 μA, the gain is set to 2, the electrolytic solution is set to ISOTON II, and “Flush Aperture Tube After Measurement” is checked.

On the “Pulse-to-Particle Size Conversion Setting” screen of the dedicated software, the bin interval is set to logarithmic particle diameter, the particle diameter bin is set to a 256 particle diameter bin, and a particle diameter range is set to 2 μm to 60 m.

The specific measurement method is as follows.

(1) A total of 200.0 mL of the aqueous electrolytic solution is poured into a 250 mL round-bottom glass beaker made exclusively for the Multisizer 3, the beaker is set on the sample stand, and counterclockwise stirring is performed with a stirrer rod at 24 revolutions per second. Then, the “Flush Aperture Tube” function of the dedicated software is used to remove dirt and air bubbles from inside the aperture tube.

(2) A total of 30.0 mL of the aqueous electrolytic solution is poured into a 100 mL flat-bottom glass beaker. To this, 0.3 mL of a diluted solution of “Contaminon N” (a 10% aqueous solution of a neutral detergent for cleaning precision measuring instruments with a pH of 7 consisting of a nonionic surfactant, an anionic surfactant, and an organic builder, manufactured by Wako Pure Chemical Industries, Ltd.) that was diluted three-fold by mass with ion-exchanged water is added as a dispersing agentⁱ.

(3) An ultrasonic disperser “Ultrasonic Dispersion System Tetra 150” (manufactured by Nikkaki Bios Co., Ltd.) that has two built-in oscillators with an oscillation frequency of 50 kHz and a phase shift of 180 degrees, and has an electrical output of 120 W is prepared. A total of 3.3 L of ion-exchanged water is poured into the water tank of the ultrasonic disperser, and 2.0 mL of Contaminon N is added to the water tank.

(4) The beaker of (2) is set in the beaker fixing hole of the ultrasonic disperser, and the ultrasonic disperser is operated. The height position of the beaker is adjusted so that the resonance state of the aqueous electrolytic solution in the beaker is maximized.

(5) While the aqueous electrolytic solution in the beaker (4) is irradiated with ultrasonic waves, 10 mg of toner is added little by little to the aqueous electrolytic solution and dispersed. Then, the ultrasonic dispersion process is continued for another 60 sec. During ultrasonic dispersion, the water temperature of the water tank is adjusted, as appropriate, to be from 10° C. to 40° C.

(6) The aqueous electrolytic solution of (5) in which the toner particles are dispersed is dropped using a pipette into the round-bottom beaker (1) installed in the sample stand, and the measurement concentration is adjusted to 5%. Then, the measurement is continued until the number of measured particles reaches 50,000.

(7) The measurement data are analyzed using dedicated software provided with the device, and the number average particle diameter (D1) is calculated. When the dedicated software is set to graph/volume %, the “Average diameter” on the “Analysis/Volume Statistics (Arithmetic Mean)” screen is the weight-average particle diameter (D4), and when the dedicated software is set to graph/number %, the “Average diameter” on the “Analysis/Number Statistics (Arithmetic Mean)” screen is the number-average particle diameter (D1).

### EXAMPLES

The present disclosure will be specifically explained below using examples, but these do not limit the present disclosure in any way. In the following formulations, parts are by mass unless otherwise specified.

### Preparation of Polymerizable Monomer (a-1)

A total of 727.0 parts of cetanol, 175.0 parts of fumaric acid, 2.5 parts of dibutyltin oxide, and 1 part of 2,6-di-tert-butyl-p-cresol were added to a pressurized reaction vessel equipped with a stirrer, a temperature controller, a thermometer, an air introducing tube, a pressure reducing device, and a water reducer, and the components were homogenized by stirring at 120° C. After that, the temperature was raised to 165° C., and the mixture was esterified under reduced pressure at 21 kPa for 3 h while removing distilled water. After confirming that the acid value was less than 30.0 mgKOH/g, the mixture was esterified under reduced pressure at 3 kPa or less for 12 h while removing distilled water. The esterification product was taken out to obtain a polymerizable monomer (a-1).

### Preparation of Polymerizable Monomers (a-2) to (a-10)

Polymerizable monomers (a-2) to (a-10) were produced in the same manner as in the preparation example of the polymerizable monomer (a-1), except that the types of raw materials and the number of parts added were changed as shown in Table 1. The compositions of polymerizable monomers (a-2) to (a-10) are shown in Table 1.

TABLE 1

| | Unsaturated polyvalent | | | | | | | |
|---|---|---|---|---|---|---|---|---|
| Polymerizable | carboxylic acid | | Long-chain alcohol | | Structure of monomer unit (a) | | | |
| monomer a | Type | Parts | Type | Parts | R1 | R2 | R3 | R4 |
| (a-1) | Fumaric acid | 175.0 | Cetanol | 727.0 | —COOC16H33 | H | H | —COOC16H33 |
| (a-2) | Fumaric acid | 175.0 | Stearyl alcohol | 811.0 | —COOC18H37 | H | H | —COOC18H37 |
| (a-3) | Fumaric acid | 175.0 | Behenyl alcohol | 979.0 | —COOC22H45 | H | H | —COOC22H45 |
| (a-4) | Fumaric acid | 175.0 | Octacosanol | 1232.0 | —COOC28H57 | H | H | —COOC28H57 |
| (a-5) | Fumaric acid | 175.0 | Myricyl alcohol | 1316.0 | —COOC30H61 | H | H | —COOC30H61 |
| (a-6) | Maleic acid | 175.0 | Behenyl alcohol | 979.0 | —COOC22H45 | H | —COOC22H45 | H |
| (a-7) | Fumaric acid | 178.0 | Behenyl alcohol | 978.0 | —COOC22H45 | H | H | —COOC22H45 |
| (a-8) | Fumaric acid | 182.5 | Behenyl alcohol | 978.0 | —COOC22H45 | H | H | —COOC22H45 |
| (a-9) | Fumaric acid | 175.0 | Lauryl alcohol | 559.0 | —COOC12H25 | H | H | —COOC12H25 |
| (a-10) | Fumaric acid | 175.0 | Dotriacontanol | 1396.0 | —COOC32H65 | H | H | —COOC32H65 |

### Preparation of Crystalline Vinyl Resin (A-1)

A total of 120.0 parts of xylene and 80.0 parts of the polymerizable monomer (a-1) were charged into an autoclave, and the temperature was raised to 135° C. while stirring in a sealed state, and then the pressure was released. Thereafter, the temperature was raised to 155° C. while stirring in a sealed state. A mixed solution of 14.0 parts of methacrylonitrile, 6.0 parts of styrene, 1.6 parts of di-t-butyl peroxide, and 60.0 parts of xylene was dropwise added over 3 h while controlling the temperature inside the autoclave to 155° C., and polymerization was carried out. After dropwise addition, the dropping line was washed with 20.0 parts of xylene. After holding at the same temperature for another 2.2 h and then cooling to 70° C., 12.8 parts of di-t-butyl peroxide was added and reacted. The solvent was then removed at 170° C. for 3 h under reduced pressure of 0.5 kPa to 2.5 kPa to obtain a crystalline vinyl resin (A-1). It was confirmed that the crystalline vinyl resin (A-1) is a crystalline resin that shows a clear endothermic peak in differential scanning calorimetry (DSC) measurements.

### Preparation of Crystalline Vinyl Resins (A-2) to (A-22)

Crystalline vinyl resins (A-2) to (A-22) were produced in the same manner as the crystalline vinyl resin (A-1), except that the types and amounts of raw materials added were changed as shown in Table 2. It was confirmed that the crystalline vinyl resins (A-2) to (A-22) are crystalline resins that show a clear endothermic peak in differential scanning calorimetry (DSC) measurements. The compositions and physical properties of the crystalline vinyl resins (A-2) to (A-22) are shown in Table 2.

TABLE 2

| | First | | Second | | Third | |
|---|---|---|---|---|---|---|
| Crystalline | polymerizable | | polymerizable | | polymerizable | |
| vinyl resin | monomer | | monomer | | monomer | |
| No. | Type | Amount | Type | Amount | Type | Amount |
| A1 | Polymerizable | 80.0 | Methacrylonitrile | 14.0 | Styrene | 6.0 |
| | monomer (a-1) | | | | | |
| A2 | Polymerizable | 80.0 | Methacrylonitrile | 14.0 | Styrene | 6.0 |
| | monomer (a-2) | | | | | |
| A3 | Polymerizable | 80.0 | Methacrylonitrile | 14.0 | Styrene | 6.0 |
| | monomer (a-3) | | | | | |
| A4 | Polymerizable | 80.0 | Methacrylonitrile | 14.0 | Styrene | 6.0 |
| | monomer (a-4) | | | | | |
| A5 | Polymerizable | 80.0 | Methacrylonitrile | 14.0 | Styrene | 6.0 |
| | monomer (a-5) | | | | | |
| A6 | Polymerizable | 80.0 | Methacrylonitrile | 14.0 | Styrene | 6.0 |
| | monomer (a-6) | | | | | |
| A7 | Polymerizable | 80.0 | Methacrylonitrile | 14.0 | Styrene | 6.0 |
| | monomer (a-7) | | | | | |
| A8 | Polymerizable | 80.0 | Methacrylonitrile | 14.0 | Styrene | 6.0 |
| | monomer (a-8) | | | | | |
| A9 | Polymerizable | 80.0 | Methacrylonitrile | 14.0 | Styrene | 6.0 |
| | monomer (a-9) | | | | | |
| A10 | Polymerizable | 80.0 | Methacrylonitrile | 14.0 | Styrene | 6.0 |
| | monomer (a-10) | | | | | |
| A11 | Polymerizable | 5.5 | Methacrylonitrile | 14.0 | Styrene | 80.5 |
| | monomer (a-3) | | | | | |
| A12 | Polymerizable | 33.0 | Methacrylonitrile | 14.0 | Styrene | 53.0 |
| | monomer (a-3) | | | | | |
| A13 | Polymerizable | 28.0 | Methacrylonitrile | 14.0 | Styrene | 58.0 |
| | monomer (a-3) | | | | | |
| A15 | Polymerizable | 44.0 | Methacrylonitrile | 14.0 | Styrene | 6.0 |
| | monomer (a-3) | | | | | |
| A16 | Polymerizable | 36.0 | Methacrylonitrile | 14.0 | Styrene | 6.0 |
| | monomer (a-3) | | | | | |
| A18 | Polymerizable | 80.0 | Styrene | 20.0 | None | — |
| | monomer (a-3) | | | | | |
| A19 | Polymerizable | 80.0 | Methyl acrylate | 14.0 | Styrene | 6.0 |
| | monomer (a-3) | | | | | |
| A20 | Polymerizable | 80.0 | Acrylamide | 14.0 | Styrene | 6.0 |
| | monomer (a-3) | | | | | |
| A21 | None | — | Methacrylonitrile | 14.0 | Styrene | 20.0 |
| A22 | Polymerizable | 4.5 | Methacrylonitrile | 14.0 | Styrene | 81.5 |
| | monomer (a-3) | | | | | |

| | Fourth | | | | | | |
|---|---|---|---|---|---|---|---|
| Crystalline | polymerizable | | | | | | |
| vinyl resin | monomer | | Ratio J | | | Acid | [SPb · |
| No. | Type | Amount | mass % | mol % | Ratio K | value | SPa] |
| A1 | None | — | 80.0 | 34.7 | 100.0 | 0.7 | 7.4 |
| A2 | None | — | 80.0 | 32.6 | 100.0 | 0.7 | 7.5 |
| A3 | None | — | 80.0 | 29.1 | 100.0 | 0.7 | 7.7 |
| A4 | None | — | 80.0 | 25.0 | 100.0 | 0.7 | 7.8 |
| A5 | None | — | 80.0 | 23.9 | 100.0 | 0.7 | 7.9 |
| A6 | None | — | 80.0 | 29.1 | 100.0 | 0.7 | 7.7 |
| A7 | None | — | 80.0 | 29.1 | 100.0 | 3.0 | 7.7 |
| A8 | None | — | 80.0 | 29.1 | 100.0 | 6.1 | 7.7 |
| A9 | None | — | — | 39.9 | — | 0.7 | 7.1 |
| A10 | None | — | — | 22.9 | — | 0.7 | 8.1 |
| A11 | None | — | 5.5 | 0.8 | 100.0 | 0.1 | 7.7 |
| A12 | None | — | 33.0 | 5.9 | 100.0 | 0.4 | 7.7 |
| A13 | None | — | 28.0 | 4.8 | 100.0 | 0.3 | 7.7 |
| A15 | Behenyl | 36.0 | 44.0 | 14.3 | 55.0 | 0.5 | 7.7 |
| | acrylate | | | | | | |
| A16 | Behenyl | 44.0 | 36.0 | 11.4 | 45.0 | 0.3 | 7.7 |
| | acrylate | | | | | | |
| A18 | None | — | 80.0 | 36.2 | 100.0 | 0.7 | 1.8 |
| A19 | None | — | 80.0 | 33.1 | 100.0 | 0.7 | 3.3 |
| A20 | None | — | 80.0 | 30.0 | 100.0 | 0.7 | 21.0 |
| A21 | Behenyl | 80.0 | — | 0.0 | — | 1.0 | — |
| | acrylate | | | | | | |
| A22 | None | — | 4.5 | 0.6 | 100.0 | 0.1 | 7.7 |

In the table, the ratio J indicates the content ratio of the monomer unit (a) represented by formula (1) based on the mass of the crystalline vinyl resin (A).

The ratio K indicates the content ratio (mass %) of the monomer unit (a) among monomer units having an alkyl group with 16 to 30 carbon atoms, including the monomer unit (a), in the crystalline vinyl resin (A).

The unit of acid value is mgKOH/g.

### Preparation of Shell Resin (S1)

The following materials were added to an autoclave equipped with a pressure reducing device, a water separator, a nitrogen gas introducing device, a temperature measuring device, and a stirrer.

| | |
|---|---|
| Terephthalic acid | 25.3 parts |
| Bisphenol A-propylene oxide 2-mol adduct | 74.7 parts |
| Potassium titanium oxalate (catalyst) | 0.02 parts |

Then, the reaction was carried out under a nitrogen atmosphere at normal pressure at 220° C. After the temperature was reduced, the mixture was pulverized to obtain a shell resin (S1) (amorphous polyester (amorphous PES)).

### Preparation of Shell Resins (S2), (S3), and (S4)

The following materials were placed in a reaction vessel equipped with a reflux condenser, a stirrer, a thermometer, and a nitrogen introducing tube under a nitrogen atmosphere.

| | |
|---|---|
| Solvent: toluene | 100.0 parts |
| Styrene | 74.0 parts |
| Acrylonitrile | 9.0 parts |
| Methacrylic acid | 8.0 parts |
| 2-Hydroxyethyl methacrylate | 9.0 parts |
| Polymerization initiator: t-butyl peroxypivalate | 5.0 parts |
| (Perbutyl PV, manufactured by NOF Corp.) | |

The inside of the reactor was heated to 70° C. while stirring at 200 rpm, and the polymerization reaction was carried out for 12 h to obtain a solution in which the polymer of the monomer composition was dissolved in toluene. After the solution temperature was lowered to 25° C., the solution was poured into 1000.0 parts of methanol while stirring, and a methanol insoluble matter was precipitated. The obtained methanol insoluble matter was filtered off, washed with methanol, and vacuum dried at 40° C. for 24 h to obtain a shell resin (S2). Shell resins (S3) and (S4) were obtained using the same production method, except that the raw material composition of the shell resin (S2) was changed as shown in Table 3.

### Preparation of Shell Resin (S5)

The following materials were added to an autoclave equipped with a pressure reducing device, a water separator, a nitrogen gas introducing device, a temperature measuring device, and a stirrer.

| | |
|---|---|
| Sebacic acid | 64.2 parts |
| 1,6-Hexanediol | 35.8 parts |
| Potassium titanium oxalate (catalyst) | 0.06 parts |

Then, the reaction was carried out under a nitrogen atmosphere at normal pressure at 220° C. A shell resin (S5) (crystalline polyester (crystalline PES)) was obtained by pulverization after the temperature was lowered.

TABLE 3

| Shell resin | | S1 | S2 | S3 | S4 | S5 |
|---|---|---|---|---|---|---|
| Amount of | Terephthalic acid | 25.3 | — | — | — | 0.0 |
| PES monomer | Isophthalic acid | 0.0 | — | — | — | 0.0 |
| charged (parts) | BPA-PO 2 mol adduct | 74.7 | — | — | — | 0.0 |
| | Sebacic acid | 0.0 | — | — | — | 64.2 |
| | 1,6-Hexane diol | 0.0 | — | — | — | 35.8 |
| Amount of | Styrene | — | 74.0 | 90.0 | 65.0 | — |
| vinyl monomer | Acrylonitrile | — | 9.0 | 1.0 | 30.0 | — |
| charged (parts) | Methacrylic acid | — | 8.0 | 3.0 | 2.0 | — |
| | 2-HEMA | — | 9.0 | 6.0 | 3.0 | — |
| Physical | Resin type | Amorphous | Amorphous | Amorphous | Amorphous | Crystalline |
| properties | | PES | vinyl | vinyl | vinyl | PES |
| | SP value (J/cm³)^{0.5} | 20.3 | 21.3 | 20.3 | 22.3 | 20.3 |

BPA-PO 2 mole adduct refers to bisphenol A-propylene oxide 2 mole adduct. 2-HEMA refers to 2-hydroxyethyl methacrylate.

### Example 1

### Production of Toner Particle 1

| | |
|---|---|
| n-Butyl acrylate (referred to as BA in the table) | 20.0 parts |
| Styrene | 30.0 parts |
| Colorant: Pigment Blue 15:3 | 6.5 parts |

A mixture of the above materials was prepared. The mixture was placed in an attritor (manufactured by Nippon Coke Corporation) and dispersed for 2 h at 200 rpm using zirconia beads with a diameter of 5 mm to obtain a raw material dispersion liquid.

Meanwhile, 735.0 parts of ion-exchanged water and 16.0 parts of trisodium phosphate (12-hydrate) were added to a container equipped with a high-speed stirring device Homomixer (manufactured by Primix Corporation) and a thermometer, and the temperature was raised to 60° C. while stirring at 12,000 rpm. An aqueous calcium chloride solution prepared by dissolving 9.0 parts of calcium chloride (dihydrate) in 65.0 parts of ion-exchanged water was added thereto, and stirring was carried out at 12,000 rpm for 30 min while maintaining the temperature at 60° C. Then, 10% hydrochloric acid was added thereto to adjust the pH to 6.0, yielding an aqueous medium in which an inorganic dispersion stabilizer containing hydroxyapatite was dispersed in water.

The raw material dispersion liquid was then transferred to a container equipped with a stirrer and a thermometer, and the temperature was raised to 60° C. while stirring at 100 rpm.

| | |
|---|---|
| Crystalline vinyl resin (A3) | 50.0 parts |
| Release agent (DP18) | 9.0 parts |
| DP18 (dipentaerythritol stearate wax, melting point | |
| 79° C., manufactured by Nisshin Oillio Co., Ltd.) | |
| Shell resin (S1) | 6.0 parts |

The above materials were added and stirred at 100 rpm for 30 min while keeping the temperature at 60° C., after which 5.0 parts of t-butyl peroxypivalate (manufactured by NOF Corp.: Perbutyl PV) was added as a polymerization initiator and then stirring was performed for another minute. The mixture was then charged into the aqueous medium being stirred at 12,000 rpm with the high-speed stirring device. Stirring was continued for 20 min at 12,000 rpm with the high-speed stirring device while keeping the temperature at 60° C., and a granulation liquid was obtained.

The granulation liquid was transferred to a reaction vessel equipped with a reflux condenser, a stirrer, a thermometer, and a nitrogen introducing tube, and heated to 70° C. while stirring at 150 rpm under a nitrogen atmosphere. The polymerization reaction was carried out at 150 rpm for 12 h while keeping the temperature at 70° C. Until solidification in the course of the polymerization reaction, a high-polarity material is present on the water side and a low-polarity material is present on the inside, so the shell resin forms a shell on the outside of the toner particle, and the other materials become a core present inside the toner particle. The obtained dispersion liquid was cooled to 55° C. while stirring at 150 rpm.

### Step of Forming Second Shell

### Step of Hydrolyzing Organosilicon Compound for Second Shell

As a pretreatment for the second shell formation, the following was carried out in parallel with the above polymerization reaction. A total of 60.0 parts of ion-exchanged water was weighed out into a reaction vessel equipped with a stirrer and a thermometer, and the pH was adjusted to 3.0 using 10% by mass hydrochloric acid. Heating was then performed under stirring to set the temperature to 55° C. Then, 40.0 parts of methyltriethoxysilane (MTES) as an organic silicon compound for the surface layer was added and a hydrolysis reaction was carried out. The end point of the hydrolysis was visually confirmed when the oil and water did not separate and became a single layer. Subsequent cooling yielded a hydrolysate of the organic silicon compound for the surface layer.

### Formation of Second Shell

While stirring of the dispersion liquid obtained in the polymerization step at 55° C. was continued, 20.0 parts of the hydrolysate of the organic silicon compound for the surface layer was added to start the formation of the toner surface layer. After holding the mixture as it was for 30 min, the slurry was adjusted to pH=9.0 using an aqueous sodium hydroxide solution to complete the condensation. After subsequent holding for 300 min, a second shell was formed and a toner particle dispersion liquid was obtained.

The obtained toner particle dispersion liquid was cooled to 30° C. while stirring at 150 rpm. Then, dilute hydrochloric acid was added while maintaining stirring until the pH reached 1.5 to dissolve the dispersion stabilizer. The solid fraction was filtered off, thoroughly washed with ion-exchanged water, and then vacuum-dried at 30° C. for 24 h to obtain toner particle 1.

### Preparation and Evaluation of Toner 1

A total of 2.0 parts of silica fine particles (hydrophobized with hexamethyldisilazane, number-average particle diameter of primary particles: 10 nm, BET specific surface area: 170 m²/g) were added as an external additive to 100.0 parts of toner particle 1, and mixing was performed for 15 min at 3000 rpm using a Henschel mixer (manufactured by Nippon Coke Corporation) to obtain toner 1. The obtained toner 1 was evaluated by the following method. The physical properties of the toner are shown in Table 4, and the evaluation results are shown in Table 5.

### Toner Evaluation Methods

### Low-Temperature Fixability

A process cartridge filled with the toner for evaluation was allowed to stand for 48 h in a normal temperature and humidity environment (temperature 23° C., relative humidity 50%). An LBP-712Ci modified to enable operation even when the fixing unit was removed was used, and an unfixed image of an image pattern in which 10 mm×10 mm square images were evenly arranged in 9 points over the entire transfer paper was output. The toner laid-on level on the transfer paper was 0.80 mg/cm², and the fixing start temperature was evaluated. The transfer paper used was A4 paper (“Prover Bond Paper”: 105 g/m², manufactured by Fox River).

The fixing unit used was an external fixing unit that had been removed from the LBP-712Ci and was able to operate outside the laser beam printer. The fixing temperature of the external fixing unit was raised in 5° C. increments from 90° C., and fixing was performed under the condition of a process speed of 260 mm/sec.

The fixed image was visually checked, and the minimum temperature at which cold offset did not occur was evaluated as the fixing start temperature. The evaluation results are shown in Table 5.

### Evaluation of Heat-Resistant Storage Stability (Blocking Resistance)

A total of 10 g of the toner for evaluation was placed in a 100 mL resin cup and allowed to stand for 7 days in an environment with a temperature of 45° C. and a relative humidity of 95%, after which the degree of agglomeration was visually confirmed, and the heat-resistant storage stability was evaluated according to the following criteria. The evaluation results are shown in Table 5.

### (Evaluation Criteria)

A: No agglomerates are observed.
B: Agglomerates are observed, but they crumble easily.
C: Agglomerates are observed, but they crumble when shaken.
D: Agglomerates can be grasped and do not crumble easily.

### Evaluation of Charge Decay Rate Coefficient

### Method for Measuring Charge Decay Rate Coefficient

The charge decay rate coefficient, which is an index of charge retention property, is measured using an electrostatic diffusion rate measuring device NS-D100 (manufactured by Nano Seeds Corporation).

First, a sample pan is filled with about 100 mg of toner as a sample, and the toner surface is scraped to make it smooth. The sample pan is irradiated with X-rays for 30 sec using an X-ray static eliminator to eliminate the charge on the sample. The de-electrified sample pan is placed on a measurement plate. A metal plate is placed on the measurement plate at the same time as a reference to zero-out the surface potential meter. The measurement plate with the sample thereon is allowed to stand in an environment of 30° C. and 80% RH for at least one hour before measurement. The measurement conditions are set as follows.
Charge time: 0.1 sec
Measurement time: 1800 sec
Measurement interval: 1 sec
Discharge polarity: −
Electrode: Yes

The initial potential is set to −600 V, and the change in surface potential immediately after charging is measured. The charge decay rate coefficient α is calculated by fitting the obtained results to the following formula.

$${V}_{t} = {V}_{0} exp ( - α {t}^{1 / 2} )$$

Vₜ: Surface potential at time t (V)
V₀: Initial surface potential (V)
t: Time from application of charge (sec)
α: Charge decay rate coefficient

### Heat Cycle Test Simulating Cargo Ship Transportation

When shipping products by sea on cargo ships, in conditions where temperature and humidity are not controlled, such as in dry containers, the products are exposed to an environment with large temperature and humidity differences between day and night depending on the region and situation, so the present conditions were set.

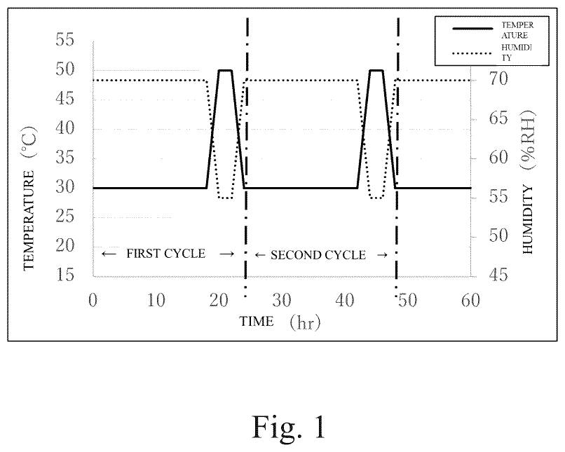

For the heat cycle test, 100 g of the toner to be evaluated was placed in a 500 ml sampler (R) Polycap (manufactured by Sanplatec Co., Ltd.). Next, the Polycap containing the toner was placed in a thermohygrostat IX210 (manufactured by Yamato Scientific Co., Ltd.) and a heat cycle test simulating dry container cargo ship transportation was carried out. The specific conditions were as follows. First, holding at a temperature of 30° C. and 70% RH for 18 h, then changing to 50° C. temperature and 55% RH over 2 h and holding for 2 h, followed by changing to a temperature of 30° C. and 70% RH over 2 h. This heat cycle was repeated 20 times. The temperature and humidity changes are illustrated in FIG. 1.

The charge decay rate coefficient was measured for each of the obtained toners before the heat cycle after production, after 10 heat cycles, and after 20 heat cycles. The values obtained are shown in Table 5.

TABLE 4

| Toner | Ratio I | Shell coverage | | T1 |
|---|---|---|---|---|
| No. | (mass %) | ratio (%) | SPs-SPA | (° C.) |
| Toner 1 | 50.0 | 98.0 | 3.5 | 55.0 |
| Toner 2 | 50.0 | 98.0 | 3.5 | 55.0 |
| Toner 3 | 50.0 | 98.0 | 3.5 | 55.0 |
| Toner 4 | 50.0 | 98.0 | 3.5 | 55.0 |
| Toner 5 | 50.0 | 98.0 | 3.5 | 55.0 |
| Toner 6 | 50.0 | 98.0 | 3.5 | 55.0 |
| Toner 7 | 50.0 | 98.0 | 3.5 | 55.0 |
| Toner 8 | 50.0 | 98.0 | 4.5 | 55.0 |
| Toner 9 | 50.0 | 98.0 | 3.5 | 35.0 |
| Toner 10 | 50.0 | 98.0 | 3.5 | 45.0 |
| Toner 11 | 50.0 | 98.0 | 3.5 | 65.0 |
| Toner 12 | 50.0 | 98.0 | 3.5 | 75.0 |
| Toner 13 | 22.0 | 98.0 | 3.5 | 55.0 |
| Toner 14 | 18.0 | 98.0 | 3.5 | 55.0 |
| Toner 15 | 50.0 | 98.0 | 3.5 | 55.0 |
| Toner 16 | 50.0 | 98.0 | 3.5 | 55.0 |
| Toner 17 | 50.0 | 98.0 | 3.5 | 55.0 |
| Toner 18 | 50.0 | 98.0 | 3.5 | 55.0 |
| Toner 19 | 50.0 | 98.0 | 3.5 | 55.0 |
| Toner 20 | 50.0 | 98.0 | 3.5 | 55.0 |
| Toner 21 | 50.0 | 98.0 | 3.5 | 55.0 |
| Toner 22 | 50.0 | 98.0 | 3.5 | 55.0 |
| Toner 23 | 50.0 | 98.0 | 3.5 | 55.0 |
| Toner 24 | 50.0 | 75.0 | 3.5 | 55.0 |
| Toner 25 | 50.0 | 65.0 | 3.5 | 55.0 |
| Toner 26 | 50.0 | 98.0 | 3.5 | 55.0 |
| Toner 27 | 50.0 | 98.0 | 3.5 | 55.0 |
| Toner 28 | 50.0 | 98.0 | 3.5 | 55.0 |
| Comparative toner 1 | 50.0 | None | — | 55.0 |
| Comparative toner 2 | 0.0 | 98.0 | — | 55.0 |
| Comparative toner 3 | 50.0 | 98.0 | 3.5 | 55.0 |
| Comparative toner 4 | 50.0 | 98.0 | 3.5 | 55.0 |
| Comparative toner 5 | 50.0 | 98.0 | 3.5 | 55.0 |
| Comparative toner 6 | 50.0 | 98.0 | 3.5 | 55.0 |
| Comparative toner 7 | 50.0 | 98.0 | 3.5 | 55.0 |
| Comparative toner 8 | 50.0 | 98.0 | 5.5 | 55.0 |

In the table, the ratio I indicates the content ratio of the crystalline vinyl resin (A) based on the mass of the binder resin.

TABLE 5

| | Low- | | | | |
|---|---|---|---|---|---|
| | temperature | | | | |
| | fixability | | | | |
| | Fixing start | | Charge decay rate coefficient | | |
| | temperature | Heat-resistant | After | After 10 heat | After 20 heat |
| | [° C.] | storage stability | production | cycles | cycles |
| Toner 1 | 100 | A | 4 | 4 | 5 |
| Toner 2 | 100 | A | 4 | 4 | 5 |
| Toner 3 | 90 | B | 4 | 6 | 8 |
| Toner 4 | 95 | A | 4 | 5 | 7 |
| Toner 5 | 110 | A | 4 | 5 | 7 |
| Toner 6 | 120 | A | 4 | 6 | 8 |
| Toner 7 | 100 | A | 4 | 30 | 50 |
| Toner 8 | 100 | C | 20 | 20 | 20 |
| Toner 9 | 95 | C | 4 | 4 | 5 |
| Toner 10 | 100 | B | 4 | 4 | 5 |
| Toner 11 | 105 | A | 4 | 4 | 5 |
| Toner 12 | 115 | A | 4 | 4 | 5 |
| Toner 13 | 110 | A | 4 | 4 | 4 |
| Toner 14 | 115 | A | 4 | 4 | 4 |
| Toner 15 | 100 | A | 4 | 15 | 30 |
| Toner 16 | 100 | A | 4 | 20 | 40 |
| Toner 17 | 100 | A | 4 | 15 | 30 |
| Toner 18 | 100 | A | 4 | 20 | 40 |
| Toner 19 | 100 | A | 4 | 15 | 30 |
| Toner 20 | 100 | A | 4 | 20 | 40 |
| Toner 21 | 100 | A | 4 | 20 | 40 |
| Toner 22 | 100 | A | 4 | 15 | 30 |
| Toner 23 | 100 | A | 4 | 15 | 30 |
| Toner 24 | 100 | A | 20 | 20 | 22 |
| Toner 25 | 100 | A | 40 | 40 | 40 |
| Toner 26 | 100 | A | 4 | 4 | 5 |
| Toner 27 | 100 | A | 4 | 8 | 15 |
| Toner 28 | 100 | A | 4 | 6 | 10 |
| Comparative toner 1 | 95 | B | 90 | 90 | 90 |
| Comparative toner 2 | 135 | D | 3 | 3 | 3 |
| Comparative toner 3 | 100 | A | 4 | 50 | 100 |
| Comparative toner 4 | 85 | D | 4 | 10 | 20 |
| Comparative toner 5 | 130 | A | 4 | 10 | 20 |
| Comparative toner 6 | 100 | A | 4 | 30 | 60 |
| Comparative toner 7 | 100 | A | 90 | 90 | 90 |
| Comparative toner 8 | 100 | D | 4 | 4 | 5 |

### Examples 2 to 28 and Comparative Examples 1 to 8

Toner particles 2 to 28 and comparative toner particles 1 to 8 were obtained in the same manner as in Example 1, except that the materials used and amounts added were changed as shown in Tables 1, 2, 3, and 6.

The step of forming the second shell was not performed when producing toner particle 27 and comparative toner particle 1. The step of forming the second shell and subsequent steps for toner particle 28 were performed as follows.

### Step of Forming Second Shell and Subsequent Steps for Toner Particle 28

While continuing to stir the dispersion liquid obtained in the polymerization step at 55° C., the pH in the reaction vessel was adjusted to 4 with a 1 mol/L aqueous solution of p-toluenesulfonic acid. A total of 6 parts of an aqueous solution of hexamethylolmelamine initial polymerization product (Mirben Resin SM-607 (solid fraction concentration 80% by mass): manufactured by Showa Denko K.K.) was added to this liquid. While continuing stirring at 150 rpm, the temperature was raised to 70° C. and kept for 2 h to form a second shell and obtain a toner particle dispersion liquid.

The obtained toner particle dispersion liquid was cooled to 30° C. while stirring at 150 rpm. Then, while maintaining stirring, dilute hydrochloric acid was added until the pH reached 1.5 to dissolve the dispersion stabilizer. The solid fraction was filtered off, thoroughly washed with ion-exchanged water, and then vacuum dried at 30° C. for 24 h to obtain toner particle 28.

Furthermore, external addition was performed in the same manner as in Example 1 to obtain toners 2 to 28 and comparative toners 1 to 8. The physical properties of the toners are shown in Table 4, and the evaluation results are shown in Table 5.

The obtained toners were analyzed using the method described above, and the values of ratio J and ratio K same as those in Table 2 were obtained.

TABLE 6

| | | Binder resin | | | | Polymer- | | | | |
|---|---|---|---|---|---|---|---|---|---|---|
| | | Crystalline | | Amorphous vinyl resin B | | ization | Resin for shell | | | |
| | | vinyl resin A | | Styrene | BA | initiator | Shell layer | | Second shell | |
| | | | Amount | Amount | Amount | Amount | | Amount | | Amount |
| Example | Toner | | added | added | added | added | Resin | added | Resin | added |
| No. | No. | Type | (parts) | (parts) | (parts) | (parts) | type | (parts) | type | (parts) |
| 1 | 1 | A3 | 50.0 | 30.0 | 20.0 | 5.0 | S1 | 6.0 | MTES | 4.0 |
| 2 | 2 | A6 | 50.0 | 30.0 | 20.0 | 5.0 | S1 | 6.0 | MTES | 4.0 |
| 3 | 3 | A1 | 50.0 | 30.0 | 20.0 | 5.0 | S1 | 6.0 | MTES | 4.0 |
| 4 | 4 | A2 | 50.0 | 30.0 | 20.0 | 5.0 | S1 | 6.0 | MTES | 4.0 |
| 5 | 5 | A4 | 50.0 | 30.0 | 20.0 | 5.0 | S1 | 6.0 | MTES | 4.0 |
| 6 | 6 | A5 | 50.0 | 30.0 | 20.0 | 5.0 | S1 | 6.0 | MTES | 4.0 |
| 7 | 7 | A11 | 50.0 | 30.0 | 20.0 | 5.0 | S1 | 6.0 | MTES | 4.0 |
| 8 | 8 | A3 | 50.0 | 30.0 | 20.0 | 5.0 | S2 | 6.0 | MTES | 4.0 |
| 9 | 9 | A3 | 50.0 | 25.0 | 25.0 | 5.0 | S1 | 6.0 | MTES | 4.0 |
| 10 | 10 | A3 | 50.0 | 28.0 | 22.0 | 5.0 | S1 | 6.0 | MTES | 4.0 |
| 11 | 11 | A3 | 50.0 | 32.0 | 18.0 | 5.0 | S1 | 6.0 | MTES | 4.0 |
| 12 | 12 | A3 | 50.0 | 35.0 | 15.0 | 5.0 | S1 | 6.0 | MTES | 4.0 |
| 13 | 13 | A3 | 22.0 | 35.0 | 43.0 | 5.0 | S1 | 6.0 | MTES | 4.0 |
| 14 | 14 | A3 | 18.0 | 35.0 | 47.0 | 5.0 | S1 | 6.0 | MTES | 4.0 |
| 15 | 15 | A13 | 50.0 | 30.0 | 20.0 | 5.0 | S1 | 6.0 | MTES | 4.0 |
| 16 | 16 | A12 | 50.0 | 30.0 | 20.0 | 1.0 | S1 | 6.0 | MTES | 4.0 |
| 17 | 17 | A15 | 50.0 | 30.0 | 20.0 | 5.0 | S1 | 6.0 | MTES | 4.0 |
| 18 | 18 | A16 | 50.0 | 30.0 | 20.0 | 5.0 | S1 | 6.0 | MTES | 4.0 |
| 19 | 19 | A7 | 50.0 | 30.0 | 20.0 | 5.0 | S1 | 6.0 | MTES | 4.0 |
| 20 | 20 | A8 | 50.0 | 30.0 | 20.0 | 5.0 | S1 | 6.0 | MTES | 4.0 |
| 21 | 21 | A18 | 50.0 | 30.0 | 20.0 | 5.0 | S1 | 6.0 | MTES | 4.0 |
| 22 | 22 | A19 | 50.0 | 30.0 | 20.0 | 5.0 | S1 | 6.0 | MTES | 4.0 |
| 23 | 23 | A20 | 50.0 | 30.0 | 20.0 | 5.0 | S1 | 6.0 | MTES | 4.0 |
| 24 | 24 | A3 | 50.0 | 30.0 | 20.0 | 5.0 | S1 | 4.0 | MTES | 4.0 |
| 25 | 25 | A3 | 50.0 | 30.0 | 20.0 | 5.0 | S1 | 3.5 | MTES | 4.0 |
| 26 | 26 | A3 | 50.0 | 30.0 | 20.0 | 5.0 | S3 | 6.0 | MTES | 4.0 |
| 27 | 27 | A3 | 50.0 | 30.0 | 20.0 | 5.0 | S1 | 6.0 | None | 0.0 |
| 28 | 28 | A3 | 50.0 | 30.0 | 20.0 | 5.0 | S1 | 6.0 | Melamine | 4.0 |
| Comparative | Comparative | A3 | 50.0 | 30.0 | 20.0 | 5.0 | None | 0.0 | None | 0.0 |
| Example 1 | toner 1 | | | | | | | | | |
| Comparative | Comparative | None | 0.0 | 60.0 | 40.0 | 5.0 | S1 | 6.0 | MTES | 4.0 |
| Example 2 | toner 2 | | | | | | | | | |
| Comparative | Comparative | A21 | 50.0 | 30.0 | 20.0 | 5.0 | S1 | 6.0 | MTES | 4.0 |
| Example 3 | toner 3 | | | | | | | | | |
| Comparative | Comparative | A9 | 50.0 | 30.0 | 20.0 | 5.0 | S1 | 6.0 | MTES | 4.0 |
| Example 4 | toner 4 | | | | | | | | | |
| Comparative | Comparative | A10 | 50.0 | 30.0 | 20.0 | 5.0 | S1 | 6.0 | MTES | 4.0 |
| Example 5 | toner 5 | | | | | | | | | |
| Comparative | Comparative | A22 | 50.0 | 30.0 | 20.0 | 5.0 | S1 | 6.0 | MTES | 4.0 |
| Example 6 | toner 6 | | | | | | | | | |
| Comparative | Comparative | A3 | 50.0 | 30.0 | 20.0 | 5.0 | S5 | 6.0 | MTES | 4.0 |
| Example 7 | toner 7 | | | | | | | | | |
| Comparative | Comparative | A3 | 50.0 | 30.0 | 20.0 | 5.0 | S4 | 6.0 | MTES | 4.0 |
| Example 8 | toner 8 | | | | | | | | | |

Table 5 clearly indicates that, as compared to Comparative Examples 1 to 8, Examples 1 to 28 have superior low-temperature fixability and heat-resistant storage stability and are less susceptible to changes in charging performance even when exposed to an environment in which significant changes in temperature and humidity occur.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-210508, filed Dec. 13, 2023 which is hereby incorporated by reference herein in its entirety.

A toner including a toner particle, wherein the toner particle includes a core containing a binder resin, and a shell covering the core, the binder resin includes a crystalline vinyl resin (A), the crystalline vinyl resin (A) containing at least 5.0% by mass of a monomer unit (a) having at least two of alkyl group having 16 to 30 carbon atoms, the shell is an amorphous resin, and the SP value of the amorphous resin and the SP value of the crystalline vinyl resin (A) satisfy specific relationship.

What is claimed is:

1. A toner comprising a toner particle, wherein
the toner particle comprises
a core comprising a binder resin, and
a shell covering the core,
the binder resin comprises a crystalline vinyl resin (A),
the crystalline vinyl resin (A) comprises at least 5.0% by mass of a monomer unit (a) represented by a following formula (1) based on a mass of the crystalline vinyl resin (A): 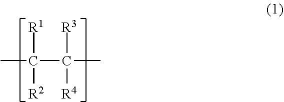
in the formula (1), at least two of R¹ to R⁴ are each independently —X—COOR⁵, and the remaining are each independently a hydrogen atom or an alkyl group having 1 to 4 carbon atoms, X is a single bond or an alkylene group having 1 or 2 carbon atoms, and R⁵ is an alkyl group having 16 to 30 carbon atoms,
the shell is an amorphous resin, and
where an SP value of the amorphous resin is SP_{S} (J/cm³)^{0.5} and an SP value of the crystalline vinyl resin (A) is SP_{A} (J/cm³)^{0.5},
the SP_{S} and the SP_{A} satisfy |SP_{S}−SP_{A}|≤5.0.

2. The toner according to claim 1, wherein
where a temperature at which a storage elastic modulus G′ of the toner becomes 1.0×10⁸ Pa is T1 (° C.) in viscoelasticity measurement of the toner,
the T1 satisfies 40.0≤T1≤70.0.

3. The toner according to claim 1, wherein the binder resin includes atleast 20.0% by mass of the crystalline vinyl resin (A) based on a mass of the binder resin.

4. The toner according to claim 1, wherein the crystalline vinyl resin (A) comprises at least 30.0% by mass of the monomer unit (a) based on the mass of the crystalline vinyl resin (A).

5. The toner according to claim 1, wherein in the crystalline vinyl resin (A), a content ratio of the monomer unit (a) among monomer units having an alkyl group with 16 to 30 carbon atoms, inclusive of the monomer unit (a), is 50.0 to 100.0% by mass.

6. The toner according to claim 1, wherein an acid value of the crystalline vinyl resin (A) is 3.0 mgKOH/g or less.

7. The toner according to claim 1, wherein
the crystalline vinyl resin (A) comprises, in addition to the monomer unit (a), a monomer unit (b) different from the monomer unit (a), and
where an SP value of the monomer unit (a) is SPa (J/cm³)^{0.5} and an SP value of the monomer unit (b) is SPb (J/cm³)^{0.5}, the SPa and the SPb satisfy a following formula (2):
$$3. \leq \vert SPb - SPa \vert \leq 21. . \qquad ( 2 )$$

8. The toner according to claim 1, wherein in an image of a cross section of the toner observed under a transmission electron microscope, the shell is observed over at least 70.0% a length of an outer periphery of the core.

9. The toner according to claim 1, wherein the shell comprises at least one selected from the group consisting of an amorphous polyester resin and an amorphous vinyl resin.

10. The toner according to claim 1, wherein in an image of a cross section of the toner observed under a transmission electron microscope, the toner particle further comprises a second shell covering the shell and that is different from the shell.

11. The toner according to claim 10, wherein the second shell is an organosilicon polymer.

12. The toner according to claim 1, wherein the binder resin further comprises an amorphous vinyl resin (B).
